(19) United States
(12) Patent Application Publication
(10) Pub. No.: US 2013/0241497 A1
(43) Pub. Date: Sep. 19, 2013

(54) BATTERY, CENTER PIN, BATTERY PACK, ELECTRONIC APPARATUS, ELECTRIC TOOL, ELECTRIC VEHICLE, ELECTRICAL STORAGE APPARATUS AND ELECTRICITY SYSTEM

(71) Applicant: SONY CORPORATION, Tokyo (JP)

(72) Inventor: Takeshi Meguro, Fukushima (JP)

(73) Assignee: SONY CORPORATION, Tokyo (JP)

(21) Appl. No.: 13/790,954

(22) Filed: Mar. 8, 2013

(30) Foreign Application Priority Data
Mar. 14, 2012 (JP) 2012-056969

(51) Int. Cl. H01M 2/12; H02J 7/00

(52) U.S. Cl. CPC H01M 2/12; H02J 7/0068
USPC 320/134; 429/94; 429/247

(57) ABSTRACT

A battery includes a spirally wound electrode body including a positive electrode and a negative electrode spirally wound, a center pin provided in the hollow portion of the spirally wound electrode body, and an exterior body configured to house the spirally wound electrode body and the center pin. The center pin includes at least one end having a plurality of cut-out portions.

### CROSS REFERENCES TO RELATED APPLICATIONS

The present application claims priority to Japanese Priority Patent Application JP 2012-056969 filed in the Japan Patent Office on Mar. 14, 2012, the entire content of which is hereby incorporated by reference.

### BACKGROUND

The present disclosure relates to a battery, a center pin, a battery pack, an electronic apparatus, an electric tool, an electric vehicle, an electrical storage apparatus and an electricity system.

Secondary batteries such as lithium-ion secondary batteries have been used as, for example, power source batteries of mobile apparatus such as laptops, electric tools, storage batteries for automobiles such as hybrid vehicles and cell automobiles, and storage batteries for power storage in combination with new energy systems such as solar cells and wind power generation.

In secondary batteries, a cylinder-type secondary battery, in which a spirally wound electrode body including spirally wound positive and negative electrodes is housed with an electrolyte solution and the like in an exterior can such as a cylindrical can, is typically used. In the cylinder-type secondary battery, there is a center pin which is inserted in the hollow center of the spirally wound electrode body.

When the secondary battery is placed under abnormal conditions of use, such as when it is thrown into the fire, the electrolyte solution inside the battery might be decomposed, and active material and binding agent would decompose and generate gas. This would cause a rapid increase of the inner pressure of the battery.

In response to this, an open end side (top side) of the battery is typically provided with a safety valve which is configured to rupture at increased inner pressure so that it is able to release the gas to the outside. On the other hand, a bottom side of the battery has no openings. The gas at the bottom side of the battery moves toward the top side, passing through the cavity of the center of the center pin disposed in the center of the spirally wound electrode body, to be released outside through the safety valve. The center pin serves to help guiding the gas generated inside the battery safely toward the top side to emit outside, when the battery has been placed under abnormal conditions of use.

Japanese Patent No. 3742350 (hereinafter referred to as Patent Document 1), Japanese Patent No. 4429253 (hereinafter referred to as Patent Document 2), Japanese Patent Application Laid-open No. 2003-317805 (hereinafter referred to as Patent Document 3), Japanese Patent Application Laid-open No. 2000-251875 (hereinafter referred to as Patent Document 4), Japanese Patent No. 3614495 (hereinafter referred to as Patent Document 5) and WO 2006/049157 (hereinafter referred to as Patent Document 6) describe techniques related to the degassing capability and the center pin.

Patent Document 1 describes a non-aqueous electrolyte secondary battery provided with a vertically long spacer to form a gas passage between an inner wall of the battery and a group of electrodes. Patent Document 2 describes a tubular core member having a cut groove formed along the longitudinal direction. Patent Document 3 describes that in order to improve impact resistance in case of being dropped, an insulating plate and a center pin are integrally made by pressing the center pin into a through-hole of the insulating plate. Patent Document 4 describes that a plurality of holes is provided on the side surface of a center pin as a technique for improving liquid infusion performance. Patent Document 5 describes that in order to improve safety in case of occurrence of short circuit by squashing the battery, a single gap is provided along the long axis of the peripheral surface of a center pin. Patent Document 6 describes that it is possible to prevent short circuit between electrodes more reliably by having a notch in a trunk portion of a center pin.

### SUMMARY

In batteries using a center pin, it is desired to improve the degassing capability and improve safety.

In view of the circumstances as described above, it is thus desirable to provide a battery capable of improving the degassing capability and improving safety, a center pin, a battery pack, an electronic apparatus, an electric tool, an electric vehicle, an electrical storage apparatus and an electricity system.

According to an embodiment of the present disclosure, there is provided a battery including a spirally wound electrode body including a positive electrode and a negative electrode spirally wound and having a hollow portion; a center pin, provided in the hollow portion of the spirally wound electrode body, including at least one end having a plurality of cut-out portions; and an exterior body configured to house the spirally wound electrode body and the center pin.

According to another embodiment of the present disclosure, there is provided a center pin including at least one end having a plurality of cut-out portions.

According to still other embodiments of the present disclosure, there is provided a battery pack using the above-described battery, an electronic apparatus, an electric tool, an electric vehicle, an electrical storage apparatus and an electricity system.

According to the present disclosure, at least one end of a center pin has a configuration with a plurality of cut-out portions. This configuration allows the performance of gas releasing to be improved, and thus is able to improve safety.

As described above, according to the present disclosure, it is possible to improve the degassing capability and improve safety.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a cross-sectional view showing a configuration example of a secondary battery according to a first embodiment of the present disclosure;

FIG. 2 is a partial enlarged cross-sectional view showing an enlarged view of an open end portion of the secondary battery shown in FIG. 1;

FIG. 3 is an enlarged cross-sectional view showing a part of the spirally wound electrode body shown in FIG. 1;

FIG. 4A is a side view of a center pin;

FIG. 4B is a partial enlarged cross-sectional view showing an enlarged view of a part (end portion) of the center pin;

FIG. 4C is a side view of a variation example of the center pin;

FIG. 5A is an enlarged perspective view of a tip end portion of a center pin;

FIG. 5B is a side view observed from the lateral side of the center pin;

FIG. 5C is a top view observed from the axial direction of the center pin;

FIG. 6A is a top view observed from the upper side of a battery cover;

FIG. 6B is a cross-sectional view of the battery cover;

FIG. 6C is a cross-sectional view for illustrating a flow of gas having passed through a center pin;

FIG. 7A is a partial enlarged view for illustrating a contact condition between a top cover and a center pin of related art;

FIG. 7B is a partial enlarged view for illustrating a contact condition between a top cover and a center pin according to an embodiment of the present disclosure;

FIG. 8A is a side view of a tip end part of a center pin having a cut-out portion of a shape including a part of a circle such as an arch shape;

FIG. 8B is a side view of a tip end part of a center pin having a cut-out portion of a triangular shape;

FIG. 8C is a side view of a tip end part of a center pin having a cut-out portion of a shape including a zigzag shape;

FIG. 8D is a side view of a tip end part of a center pin having a cut-out portion of a shape including a cross shape;

FIG. 9 is a block diagram showing a configuration example of a battery pack according to a fourth embodiment of the present disclosure;

FIG. 10 is a schematic diagram showing an application example of power storage system for houses, using a secondary battery according to an embodiment of the present disclosure;

FIG. 11 is a diagram showing schematically an example of configuration of a hybrid vehicle employing series-hybrid system in which an embodiment of the present disclosure is applied;

FIG. 12 is a side view for illustrating a shape of a cut-out portion of a tip end portion of a center pin; FIGS. 13A to 13G are top views for illustrating the number and placement of cut-out portions of the tip end portion of the center pin in Examples and Comparative Examples; and

FIG. 14 is a schematic diagram for illustrating a fire test.

### DETAILED DESCRIPTION

Hereinafter, embodiments of the present disclosure will be described with reference to the drawings. The descriptions will be made in the following order.
1. First embodiment (example of secondary battery)
2. Second embodiment (example of battery pack using secondary battery)
3. Third embodiment (example of power storage system etc. using secondary battery)
4. Other embodiments (variations)

### 1. First Embodiment

[Configuration of Battery]

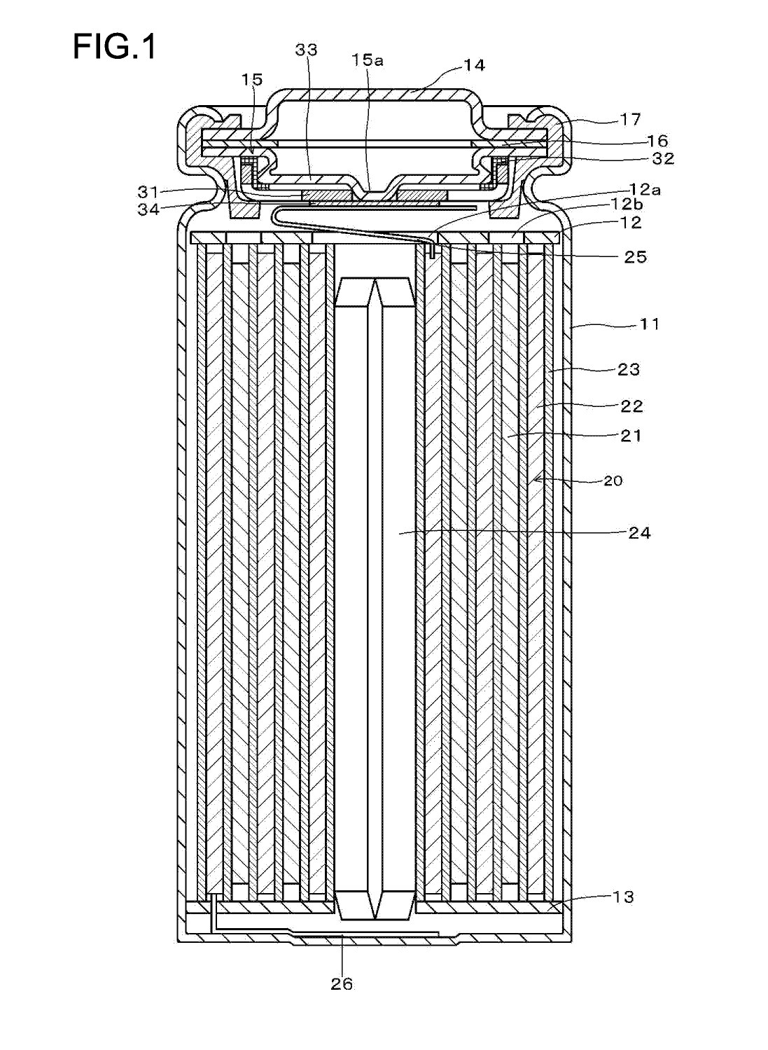

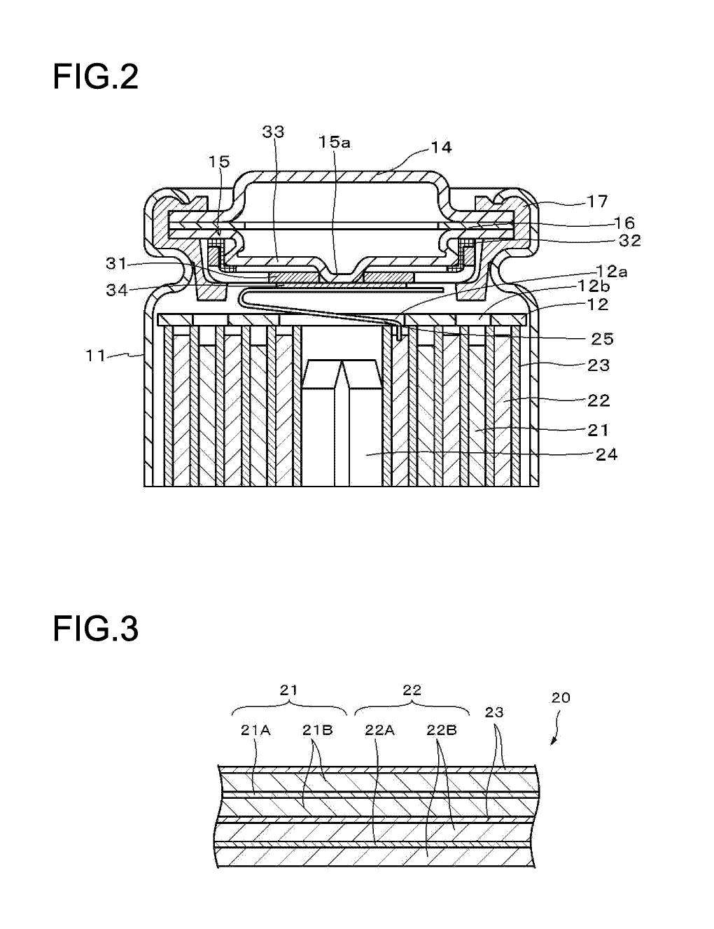

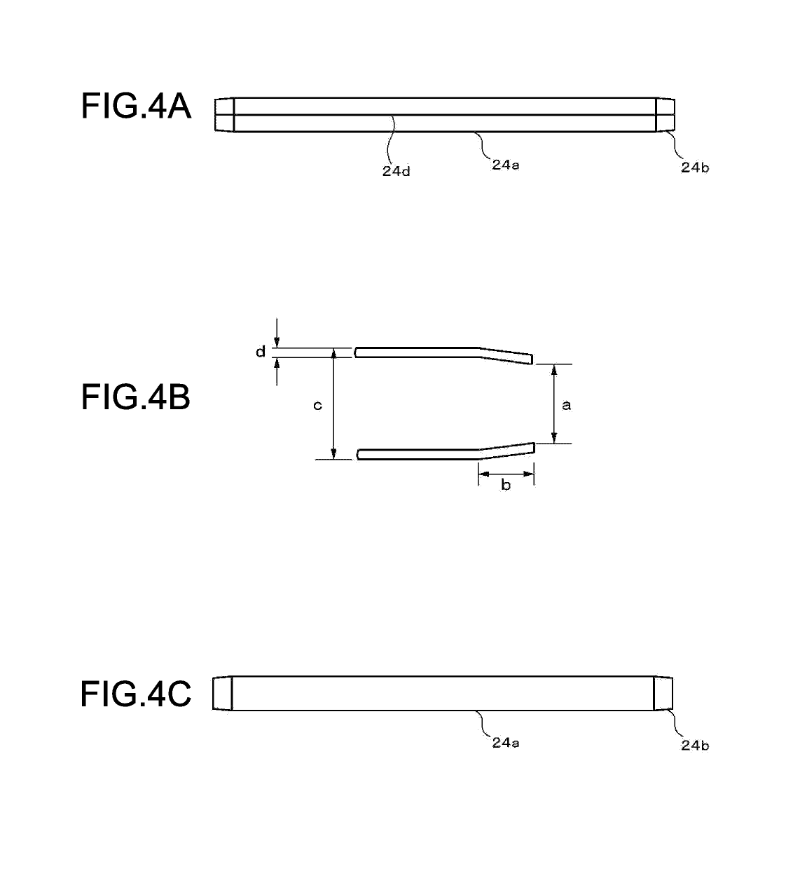

A secondary battery according to a first embodiment of the present disclosure will be described with reference to the drawings. FIG. 1 is a cross-sectional view showing a configuration example of a secondary battery according to a first embodiment of the present disclosure. FIG. 2 is a partial enlarged cross-sectional view showing an enlarged view of an open end portion of the secondary battery shown in FIG. 1. FIG. 3 is an enlarged cross-sectional view showing a part of the spirally wound electrode body shown in FIG. 1. This secondary battery is, for example, a chargeable and dischargeable secondary battery. For example, it is a lithium-ion secondary battery in which the capacity of a negative electrode 22 is represented by intercalating and deintercalating lithium as a reactive electrode material. In addition, the secondary battery is a non-aqueous electrolyte secondary battery having an electrolyte solution containing an electrolytic salt and a non-aqueous solvent as an ion conductor.

As shown in FIG. 1, this secondary battery has a hollow-columnar (cylindrical) battery can 11 which houses inside it a spirally wound electrode body 20 where a positive electrode 21 and a negative electrode 22 interposing a separator 23 in between are laminated and spirally wound, and a pair of insulating plates 12 and 13. This structure of the battery using the hollow-columnar battery can 11 is referred to as “cylinder type”. It should be noted that although the case shown in FIG. 1 is a case where the battery can 11 of a hollow columnar shape is used, the shape of the battery can 11 may also be a hollow elliptical columnar shape or others.

The battery can 11 has a hollow structure with its one end open and other end closed, for example. The battery can 11 is an exterior body configured to house the spirally wound electrode body 20. Herein, its opened one end (element insertion opening) will be referred to as “open end portion”, and the other end on the side opposite to the open end portion will be referred to as “bottom portion”. The battery can 11 is made of material such as iron (Fe), aluminum (Al) and an alloy thereof, for example. In the case where the battery can 11 is made of iron, the surface of the battery can 11 may be plated with material such as nickel (Ni), for example. The pair of insulating plates 12 and 13 is arranged in the positions sandwiching the spirally wound electrode body 20 from top and bottom. The pair of insulating plates 12 and 13 extends in a direction perpendicular to the winding peripheral surface of the spirally wound electrode body 20.

A battery cover 14, a safety valve 15 and a positive temperature coefficient device (PTC device) 16 are caulked with a gasket 17 at the open end of the battery can 11, and the battery can 11 is sealed. In addition, the insulating plate 12 is disposed between the spirally wound electrode body 20 and the safety valve 15. The battery cover 14 is made, for example, of the same material as the battery can 11. The insulating plate 12 has a central hole 12a in its center. This central hole 12a is for drawing out a positive electrode lead 25 and injecting the electrolyte solution to an inside of the battery can 11. This central hole 12a is also for allowing the gas to pass through when the inner pressure of the battery can 11 rises. An outer peripheral hole 12b around the central hole 12a is mainly for improving the performance of injection of the electrolyte solution and preventing residual of the electrolyte solution on top of the insulating plate 12.

The safety valve 15 has, for example, a support plate 31 made of a metal material such as aluminum, and an inversion plate 33 made of a metal material such as aluminum arranged on the support plate 31 with an insulating member 32 in between. For example, an opening is provided in the central portion of the support plate 31. A contact plate 34 made of a metal material such as aluminum is jointed to the central portion on the opposite side of the inversion plate 33. The contact plate 34 is electrically connected to the spirally wound electrode body 20 by being welded to the positive electrode lead 25. Further, for example, a plurality of vent holes is provided around the central portion of the support plate 31. These vent holes are for transmitting change in the inner pressure of the battery can 11 to the inversion plate 33. The inversion plate 33 includes in its center, for example, a protrusion 15a which protrudes to the spirally wound electrode body 20 side. This protrusion 15a is inserted in the opening of the support plate 31 to be contacted with the contact plate 34. Thus, the inversion plate 33 electrically connects the battery cover 14 to the positive electrode lead 25 through the PTC device 16, and allows the battery cover 14 to function as a positive electrode terminal. Further, when an increase in the inner pressure of the battery can 11 is transmitted to the inversion plate 33 through the opening of the support plate 31, the inversion plate 33 is deformed toward the battery cover 14 side to reduce the increase of the inner pressure and to block the electrical connection with the positive electrode lead 25 to block the electrical connection between the battery cover 14 and the spirally wound electrode body 20. It is also possible that the safety valve 15 is not provided with the contact plate 34, and the positive electrode lead 25 is configured to be directly contacted with the protrusion 15a of the inversion plate 33.

The PTC device 16 is configured to increase electrical resistance (and restrict the amount of electric current) in response to an increase in temperature so as to prevent abnormal generation of heat due to the large current. A gasket 17 is made of material such as insulating material, and its surface is coated with asphalt, for example.

[Spirally Wound Electrode Body]

The spirally wound electrode body 20 is an electrode body including at least the positive electrode 21 and the negative electrode 22 which are spirally wound. As shown in FIG. 3, the spirally wound electrode body 20 is, for example, the electrode body with the separator 23 between the positive electrode 21 of such as rectangular shape and the negative electrode 22 of such as rectangular shape are laminated and spirally wound in such a way that its center has a hollow portion. The outer shape of the spirally wound electrode body 20 is columnar, for example. In the spirally wound electrode body 20, the positive electrode lead 25 made of material such as aluminum is connected to the positive electrode 21, and a negative electrode lead 26 made of material such as nickel is connected to the negative electrode 22. The positive electrode lead 25 is electrically connected with the battery cover 14 by such as being welded to the safety valve 15. The anode lead 26 is electrically connected to the bottom surface or the like of the battery can 11 by such as being welded thereto.

In the hollow portion of the spirally wound electrode body 20, a rod-shaped center pin 24 with a hollow structure is provided inserted. The center pin 24 is inserted for preventing filling of the hollow portion of the spirally wound electrode body 20 in the case where the temperature inside the battery becomes high and the separator 23 shrinks, as one of its purpose. The hollow portion of the spirally wound electrode body 20 is configured to function as a discharge flow passage of the gas in the case where the gas is generated inside the battery. The center pin 24 is disposed to maintain the hollow portion of the spirally wound electrode body 20 when the temperature inside the battery is high.

[Center Pin]

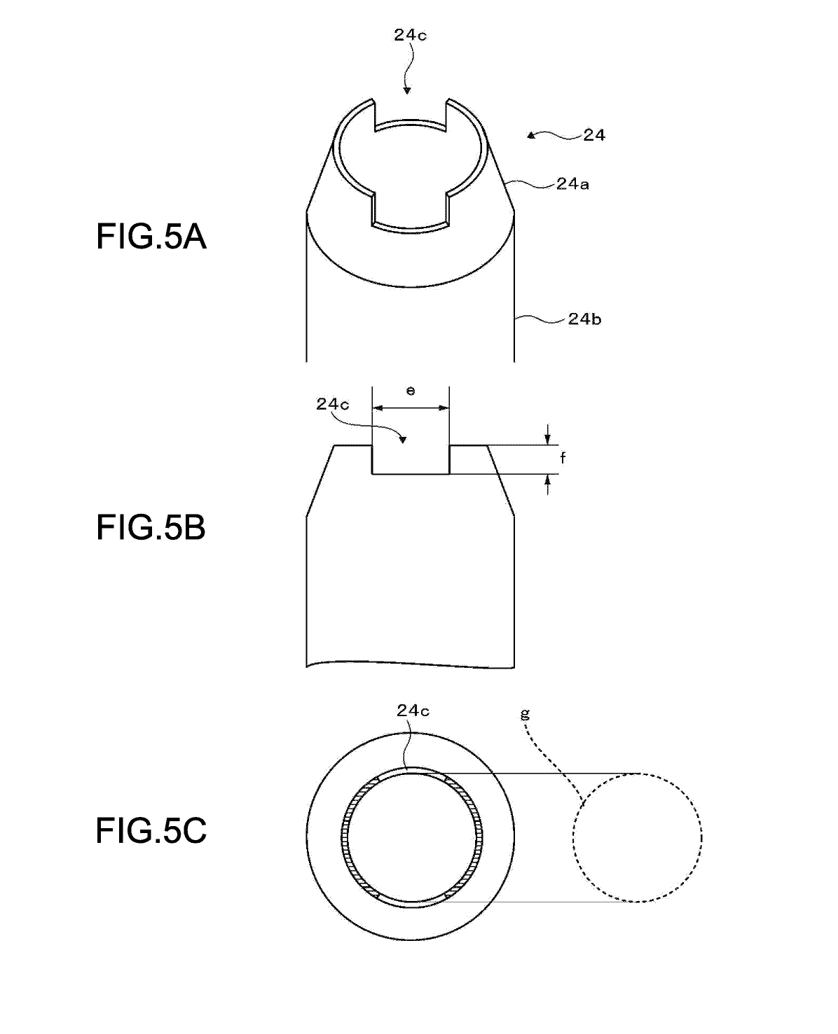

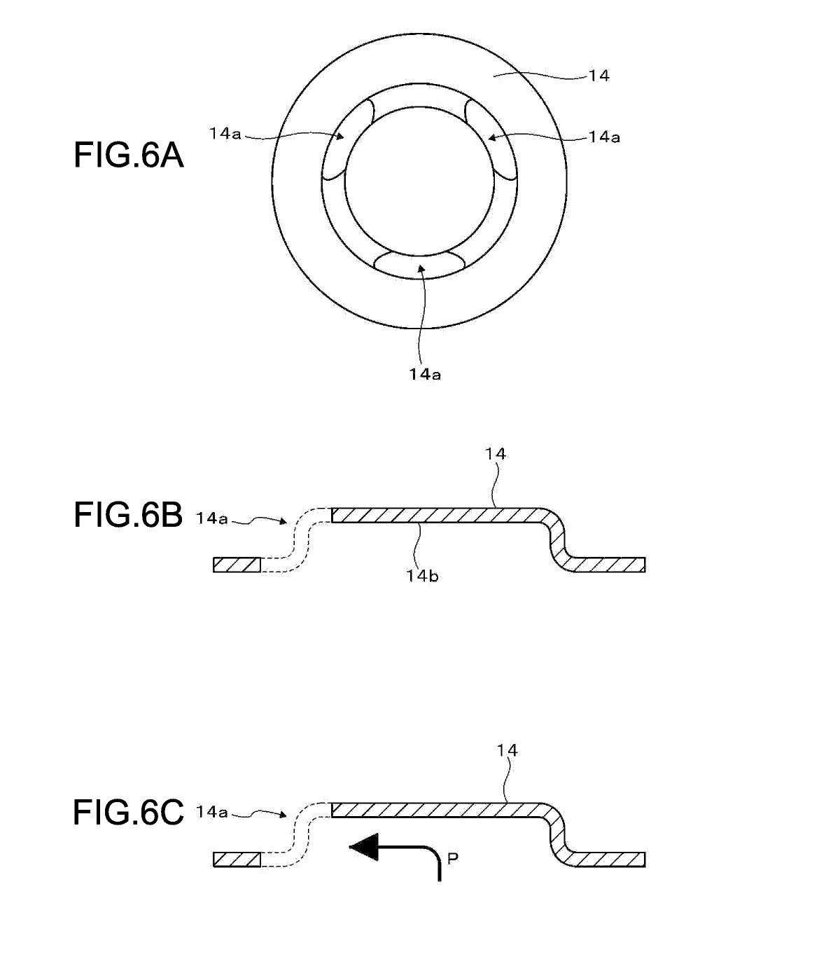

FIG. 4A shows a side view as seen from the side of a center pin. FIG. 4B is a partial enlarged cross-sectional view showing an enlarged view of a part (end portion) of the center pin. FIG. 5A is an enlarged perspective view of a tip end portion of the center pin. FIG. 5B is a side view observed from the lateral side of the center pin. FIG. 5C is a top view observed from the axial direction of the center pin.

As shown in FIG. 4, the center pin 24 is a cylindrical body having a hollow structure. The center pin 24 has a cylinder-shaped main portion 24a which is a main body of the center pin 24, and taper-shaped taper portions 24b provided at the both end portions of the center pin 24. The taper portions 24b are provided to be easily inserted into the center of the spirally wound electrode body 20. In addition, the center pin 24 has a slit 24d from one end toward the other end in the axial direction. For example, when making the center pin 24 by rolling a thin strip-shaped plate into a cylindrical shape, the slit 24d is provided by forming a clearance in between the opposing long sides of the thin plate. The width of the slit 24d is, for example, set in a length of 1% or less with respect to the length of an outer periphery of the main portion 24a. Alternatively, as shown in FIG. 4C, the center pin 24 may be in a configuration without the slit 24d. In addition, the taper portion 24b may also be provided at only one of the ends of the center pin 24.

The center pin 24 has, as one of its functions, an effect of allowing the gas to be easily emitted out of the battery by serving as the flow passage of the gas generated in the hollow portion of the center of the spirally wound electrode body 20 when the gas is generated inside the battery.

The material of the center pin 24 and its thickness may be selected such that its intensity is kept constant, as in the past. Specifically, as a constituent material of the center pin 24, there may be used a material with high strength, electrolyte solution resistance, workability, heat resistance, and not likely to undergo deformation or chipping. Examples of such a material include stainless steel and the like. The stainless steel may be subjected to nickel plating in its surface.

Hereinafter, diameter a of the inner periphery of the tip end of the center pin 24 which is shown in FIG. 4B will be referred to as “diameter of the center pin tip end portion”. Length b in the axial direction of the taper portion 24b of the center pin 24 will be referred to as “length of the taper portion”. Diameter c of the outer periphery of the main portion 24a of the center pin 24 will be referred to as “outer diameter of the center pin”. Thickness d of the material itself that make up the main portion 24a will be referred to as “thickness of the center pin 24”. Gap width e of a cut-out portion 24c based on the tip end of the center pin 24 (taper portion 24b) which is shown in FIG. 5B will be referred to as “width of the cut-out portion”. The maximum length f in the axial direction of the cut-out portion 24c which is shown in FIG. 5B will be referred to as “depth of the cut-out portion”. Length g of the inner periphery of the tip end of the center pin 24 (taper portion 24b) which is shown in FIG. 5C will be referred to as “inner peripheral length of the tip end of the center pin”.

The thickness of the center pin 24 may desirably be 0.05 mm or more and 1.0 mm or less. This is because the strength of the center pin 24 may become weak if the thickness is less than 0.05 mm, and meanwhile, it may be difficult to be rolled into a tubular shape if it is thicker than 1.0 mm. In addition, the length (axial length) may be arbitrarily designed depending on the size of the secondary battery.

[Cut-Out Portions]

As shown in FIGS. 5A to 5C, in the tip end of the center pin 24, there are provided two cut-out portions 24c in which the part of the tip end portion of the center pin 24 are cut out. The cut-out portion 24c is of such as rectangular shape as seen from the side, for example. The two cut-out portions 24c are arranged at substantially equal intervals with each other on the circumference of the tip end portion of the center pin 24.

[Effects of Cut-Out Portions]

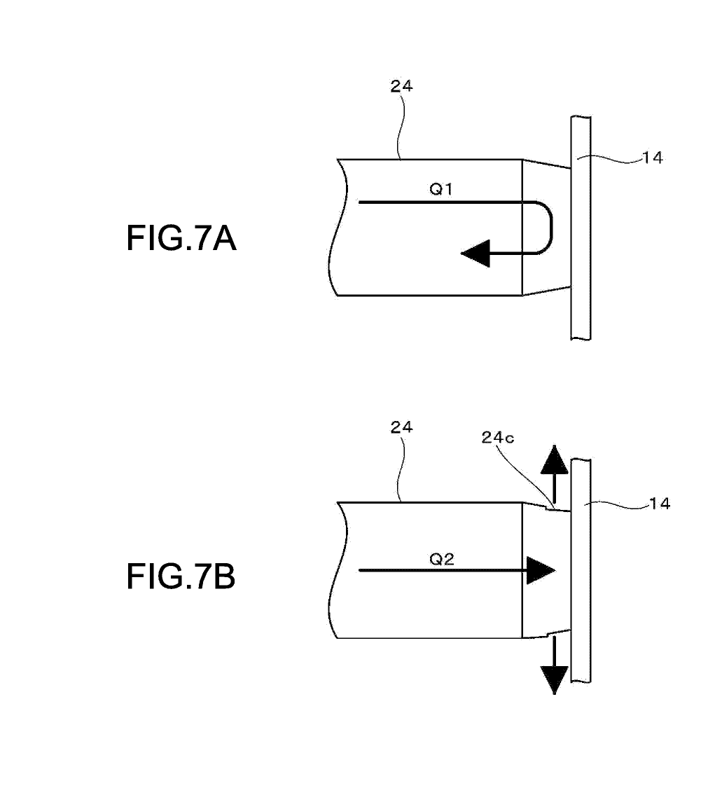

FIG. 6A is a top view observed from the upper side of the battery cover. FIG. 6B is a cross-sectional view of the battery cover. FIG. 6C is a cross-sectional view for illustrating a flow of gas having passed through the center pin 24.

As shown in FIGS. 6A and 6B, the battery cover 14 (top cover) has three openings 14a which are arranged at substantially equal intervals from one another on the circumference if observed from the upper side. Under abnormal conditions of use of the battery, when a gas ejection occurs, the gas which passes through the center pin 24 melts the insulating plate 12, the positive electrode lead 25, PTC device 16 and the safety valve 15 located at the open end portion side of the battery. As shown by the arrow P in FIG. 6C, the gas which hits the ceiling 14b of the battery cover 14 is allowed to escape outside the battery uniformly through the three openings 14a located at the lateral side of the battery cover 14, and thus the movement of the battery may be suppressed.

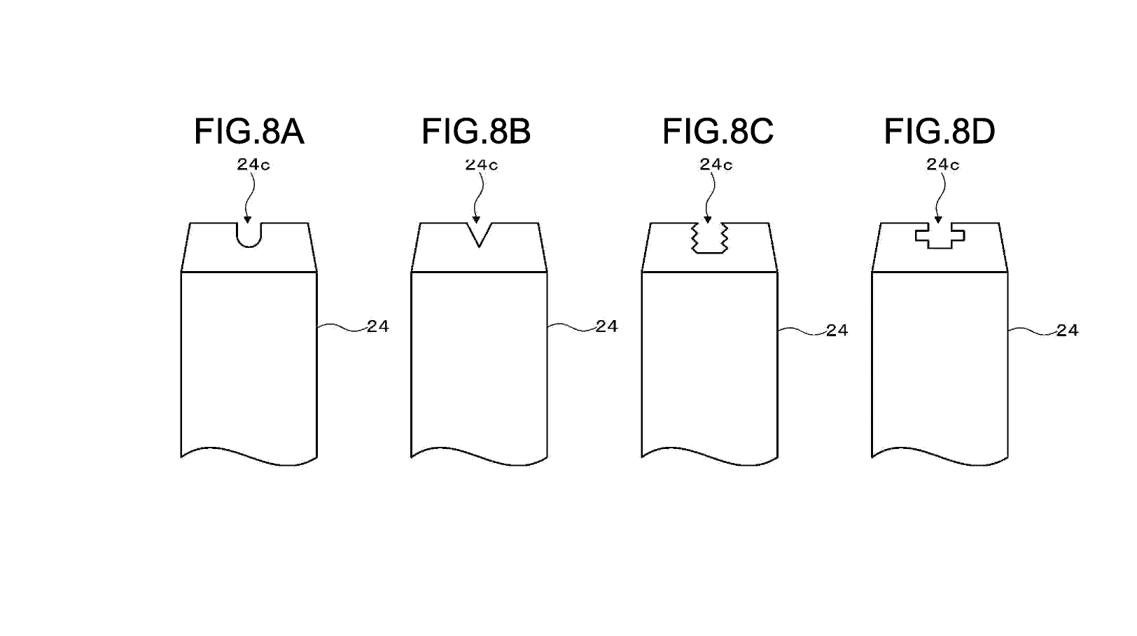

On the other hand, as shown in FIGS. 7A and 7B, the center pin 24 may abut against the battery cover 14 by moving when the gas is ejected. At this time, in the case where the center pin 24 was one with a structure of the past, as an opening at the end of the center pin 24 would be closed by the battery cover 14, the path for the gas to escape through would be blocked. As a result, as shown by the arrow Q1, since the gas cannot be released uniformly through the openings 14a of the battery cover 14, a movement of the battery would occur.

In contrast to this, with one in which the cut-out portions 24c are provided in the tip end portion of the center pin 24 as in the structure of the embodiment of the present disclosure shown in FIG. 7B, even in the case where the opening at the end of the center pin 24 is closed by the battery cover 14, the path for the gas to escape through is able to be ensured by the cut-out portions 24c. That is, as shown by the arrow Q2, the gas can be removed through the cut-out portions 24c in the side of the center pin 24. Thus, the gas may be released uniformly through the openings 14a of the battery cover 14 to the outside of the battery. Therefore, even in the case where the center pin 24 is in the state of abutting against the battery cover 14 by moving when the gas is ejected, the degassing capability is not decreased, so it is possible to prevent the movement of the battery. In addition, when the gas ejects, there may be some cases such as the case where the opening of the center pin 24 that is located at the open end portion side is closed by the safety valve 15 or the like and the case where the opening is closed by lysates of battery components such as the insulating plate being clogged. Even in those cases, the gas can be removed through the cut-out portions 24c in the side of the center pin 24 in the same manner as above, and thus it is possible to improve the degassing capability.

Meanwhile, in the technique of Patent Document 1 listed in the background art, when the gas ejection occurs, the movement of the battery might occur because the clogging of the opening of the center pin at the open end portion side cannot be avoided and it takes no measures against this. In addition, the volume of the battery cell is reduced because it includes the spacer, so the battery capacity would be lowered. In the technique of Patent Document 2, when the gas ejection occurs, the movement of the battery might occur because the clogging of the opening of the center pin at the open end portion side cannot be avoided and it takes no measures against this. In the technique of Patent Document 3, when the gas ejection occurs, the movement of the battery might occur because the clogging of the opening of the center pin at the open end portion side cannot be avoided and it takes no measures against this. In addition, the insulating plate may easily be clogged as the lysates because the insulating plate and the center pin are in an integrated form, so it is likely to cause the movement of the battery. In the technique of Patent Document 4, when the gas ejection occurs, the movement of the battery might occur because the clogging of the opening of the center pin at the open end portion side cannot be avoided and it takes no measures against this. In the technique of Patent Document 5, when the gas ejection occurs, the movement of the battery might occur because the clogging of the opening of the center pin at the open end portion side cannot be avoided and it takes no measures against this. In the technique of Patent Document 6, the degassing capability when the center pin becomes in the state of abutting against the battery cover by moving when the gas is ejected cannot be improved, because the tip end portion of the center pin is not provided with slits.

[The Number of Cut-Out Portions; Shape of Cut-Out Portions; and Placement Interval]

The number, the shape and the placement interval of the cut-out portions 24c provided in the tip-end portion of the center pin 24 are not limited to the above case which is shown in FIGS. 5A and 5B. For example, the number of the cut-out portions 24c provided in the tip-end portion of the center pin 24 is not limited to two, but may be three or more. In other words, the number of the cut-out portions 24c provided in the tip-end portion of the center pin 24 may be any of two or more (a plurality). If the number of the cut-out portions 24c is one, the battery would move because the gas is not allowed to escape uniformly when the gas ejection occurs.

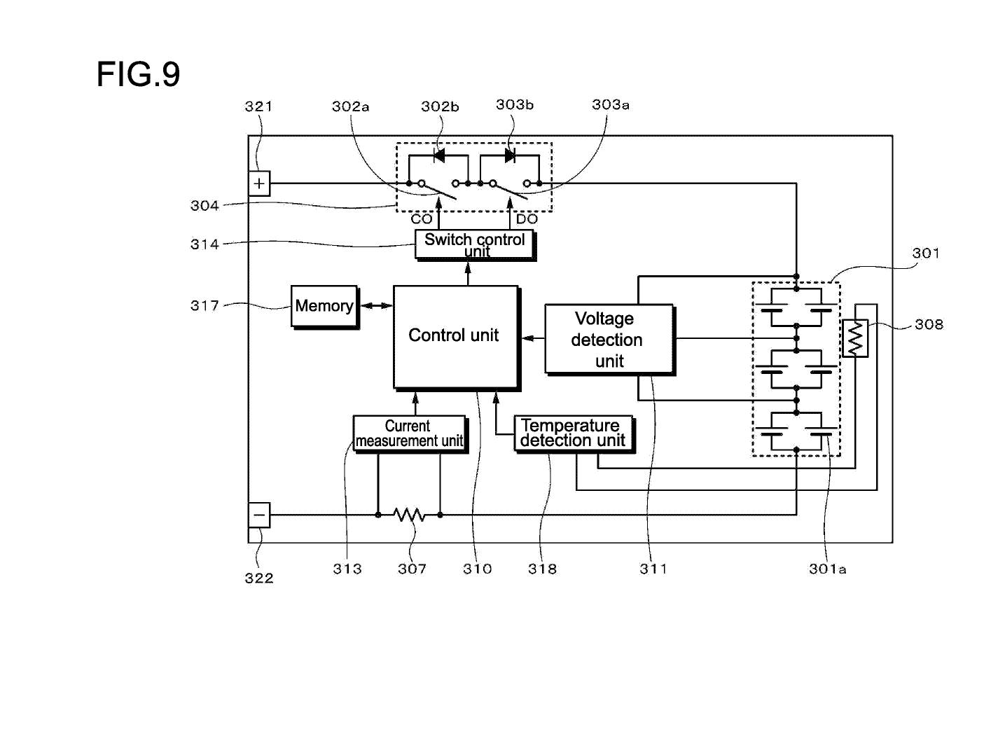

In addition, the shape of the cut-out portion 24c is not particularly limited, and may also be the shape other than rectangular or the like. Examples of the other shapes of the cut-out portion 24c when viewed from the side of the center pin 24 include a shape including a part of a circle such as an arch shape as shown in FIG. 8A, a triangular shape as shown in FIG. 8B, a shape including a zigzag shape such as a rectangular shape in which the two sides are formed in zigzag as shown in FIG. 8C, a shape including a corrugated shape such as a rectangular shape in which the two sides are corrugated (not shown), a shape including a cross shape in which the above-mentioned cut-out portions such as the rectangular cut-out portions intersect with each other as shown in FIG. 8D, and the like. In addition, the shapes including the zigzag shape include those such as triangular, rectangular, arch and cross shape in which a part thereof is formed in zigzag. The shapes including the corrugated shape include those such as triangular, rectangular, arch and cross shape in which a part thereof is corrugated. The shape of each cut-out portion 24c of the plurality of cut-out portions 24c may be substantially the same across every ones or may be different. The intervals among the cut-out portions 24c may be unequal. However, from the point of view of further improving the degassing capability, it may be desirable that the intervals are substantially equal from one another.

[Width Ratio of Cut-Out Portions]

Although the width ratio of one cut-out portion 24c is not particularly limited, it may be desirable that the width ratio of one cut-out portion 24c is 5% or more and 30% or less, in percentage of the width of one cut-out portion with respect to the inner peripheral length of the tip end of the center pin 24, for example. If the width ratio of one cut-out portion 24c is less than 5%, the degassing capability would be lowered. If the width ratio of one cut-out portion 24c is greater than 30%, when the center pin 24 moves and abuts against the battery cover 14 (top cover) during the gas ejection, the tip end of the center pin would be deformed and the opening of the center pin tends to become blocked. In addition, if the width ratio of one cut-out portion 24c is greater than 30%, the center pin 24 may easily be caught in the separator when being inserted into the center (hollow portion) of the spirally wound electrode body 20, so there is a concern that defective products would occur. The width ratio of each cut-out portion 24c of the plurality of cut-out portions 24c may be substantially the same across every ones or may be different.

It may be desirable that the total of the width ratio of the plurality of cut-out portions 24c is 60% or less, in percentage of the total width of the cut-out portions 24c with respect to the inner peripheral length of the tip end of the center pin 24. If this is greater than 60%, the strength of the tip end portion of the center pin 24 tends to be lowered. In other words, if this is greater than 60%, when the center pin 24 moves and abuts against the battery cover 14 or the safety valve 15 during the gas ejection, the tip end of the center pin would be deformed and the opening of the center pin tends to become blocked.

[Depth of Cut-Out Portions]

The plurality of cut-out portions 24c may desirably be provided within the taper portion 24b. Therefore, it may be desirable that the depth of one cut-out portion 24c is within the length of the taper portion 24b. In addition, it may be further desirable that the depth of one cut-out portion 24c is 50% or less with respect to the length of the taper portion 24b. If the depth of the cut-out portion 24c is greater than 50%, it tends to become deformed by shocks or the like, at the time of component supply. In addition, if the depth of the cut-out portion 24c is greater than the length of the taper portion, the center pin 24 tends to be caught in the separator 23 at the hollow portion of the spirally wound electrode body 20 at the time of component insertion (in other words, when the center pin 24 is inserted into the hollow portion of the spirally wound electrode body 20), so there is a tendency that component insertion failure would occur. The depth of each cut-out portion 24c of the plurality of cut-out portions 24c may be substantially the same across every ones or may be different.

The cut-out portions 24c may be provided in at least one end portion of the center pin 24 that is located at the open end portion side. However, from the point of view of making it unnecessary to adjust the insertion direction during production and thus enabling to save the trouble, it may be desirable that the cut-out portions 24c are provided in the both ends of the center pin 24.

[Positive Electrode]

The positive electrode 21 is configured to include, for example, a positive electrode current collector 21A having a pair of surfaces, and positive electrode active material layer 21B provided on both of these surfaces. However, it may otherwise be configured to have the positive electrode active material layer 21B provided on only one side of the positive electrode current collector 21A.

The positive electrode current collector 21A is made of metallic material such as aluminum, nickel, and stainless steel, for example.

The positive electrode active material layer 21B may include as positive electrode active material, one or more kinds of positive electrode materials capable of intercalating and deintercalating lithium. The positive electrode active material layer 21B may further include other material such as binding agent, conducting agent, and the like, if necessary.

Materials suitable for the positive electrode material capable of intercalating and deintercalating lithium may include, for example, a lithium-containing compound such as lithium oxide, lithium phosphate, lithium sulfide, and lithium-containing intercalation compounds, and a mixture of two or more of these compounds may also be used. For achieving high energy density, the lithium-containing compound that contains lithium, transition metal element, and oxygen (O) is desirable. Examples of such lithium-containing compounds include lithium compound oxide having a layered rock salt-type structure represented by the following formula (1) and lithium compound phosphate having an olivine-type structure represented by the following formula (2), and the like. The lithium-containing compound that contains at least one kind of transition metal element selected from the group consisting of cobalt (Co), nickel (Ni), manganese (Mn) and iron (Fe) may be more desirable. Examples of such lithium-containing compounds include lithium compound oxide having a layered rock salt-type structure represented by at least one of the following formulae (3), (4) and (5), lithium compound oxide having a spinel-type structure represented by the following formula (6), and lithium compound phosphate having an olivine-type structure represented by the following formula (7), and the like. Specifically, such examples include LiNi_{0.50}Co_{0.20}Mn_{0.30}O₂, LiₐCoO₂(a≈1), Li_{b}NiO₂(b≈1), Li_{c1}Ni_{c2}Co_{1-c2}O₂(c1≈1, 0<c2<1), Li_{d}Mn₂O₄(d≈1) and LiₑFePO₄(c≈1).

LiₚNi_{(1-q-r)}Mn_{q}M1ᵣO_{(2-y)}X_{z} (1)

(In this formula (1), M1 indicates at least one kind of element selected from the elements of Groups 2-15 excluding nickel (Ni) and manganese (Mn). X indicates at least one kind of element selected from the elements of Groups 16 and 17 excluding oxygen (O). In the formula, p, q, r, y and z are values within the range defined as 0≦p≦1.5, 0≦q≦1.0, 0≦r≦1.0, −0.10≦y≦0.20 and 0≦z≦0.2.)

LiₐM2_{b}PO₄ (2)

(In this formula (2), M2 indicates at least one kind of element selected from the elements of Groups 2-15. In the formula, a and b are values within the range defined as 0≦a≦2.0 and 0.5≦b≦2.0.)

Li_{f}Mn_{(1-g-h)}Ni_{g}M3ₕO₍₂₋ⱼ₎Fₖ (3)

(In this formula (3), M3 indicates at least one kind of element selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr) and tungsten (W). In the formula, f, g, h, j and k are values within the range defined as 0.8≦f≦1.2, 0<g<0.5, 0>h>0.5, g+h<1, −0.1≦j≦0.2 and 0≦k≦0.1. It should be noted that the composition of lithium varies depending on the charging and discharging state, and the value of f indicates the value in the fully-discharged state.)

LiₘNi₍₁₋ₙ₎M4ₙO₍₂₋ₚ₎F_{q} (4)

(In this formula (4), M4 indicates at least one kind of element selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, m, n, p and q are values within the range defined as 0.8≦m≦1.2, 0.005≦n≦0.5, −0.1≦p≦0.2 and 0≦q≦0.1. It should be noted that the composition of lithium varies depending on the charging and discharging state, and the value of m indicates the value in the fully-discharged state.)

LiᵣCo₍₁₋ₛ₎M5ₛO₍₂₋ₜ₎Fᵤ (5)

(In this formula (5), M5 indicates at least one kind of element selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, r, s, t and u are values within the range defined as 0.8≦r≦1.2, 0≦s<0.5, −0.1≦t≦0.2 and 0≦u≦0.1. It should be noted that the composition of lithium varies depending on the charging and discharging state, and the value of r indicates the value in the fully-discharged state.)

LiᵥMn_{2-w}M6_{w}OₓF_{y} (6)

(In this formula (6), M6 indicates at least one kind of element selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr) and tungsten (W). In the formula, v, w, x and y are values within the range defined as 0.9≦v≦1.1, 0≦w<0.6, 3.7≦x≦4.1 and 0≦y≦0.1. It should be noted that the composition of lithium varies depending on the charging and discharging state, and the value of v indicates the value in the fully-discharged state.)

Li_{z}M7PO₄ (7)

(In this formula (7), M7 indicates at least one kind of element selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W) and zirconium (Zr). In the formula, z is a value within the range defined as 0.9≦z≦1.1. It should be noted that the composition of lithium varies depending on the charging and discharging state, and the value of z indicates the value in the fully-discharged state.)

There are other examples of materials as the positive electrode material capable of intercalating and deintercalating lithium, and such other examples include inorganic compounds that do not contain lithium such as MnO₂, V₂O₅, V₆O₁₃, NiS and MoS.

The positive electrode material capable of intercalating and deintercalating lithium may be other than those above. Further, the positive electrode materials as listed above may also be mixed in any combination of two or more.

Examples of the binding agents include synthetic rubber such as styrene-butadiene rubber, fluorine-based rubber and ethylene-propylene-diene rubber, and polymeric materials such as polyvinylidene fluoride, and others. These can be used either alone or in mixture of at least two thereof

Examples of the conducting agents include carbon materials such as graphite and carbon black, and others. These can be used either alone or in mixture of at least two thereof In addition, the conducting agent may be material such as metallic material or conductive polymer material, as long as the material is conductive.

[Negative Electrode]

The negative electrode 22 is configured to include, for example, a negative electrode current collector 22A having a pair of surfaces, and negative electrode active material layer 22B provided on both of these surfaces. However, it may otherwise be configured to have the negative electrode active material layer 22B provided on only one side of the negative electrode current collector 22A.

The negative electrode current collector 22A is made of metallic material such as copper, nickel, and stainless steel, for example.

The negative electrode active material layer 22B may include as negative electrode active material, one or more kinds of negative electrode materials capable of intercalating and deintercalating lithium. The negative electrode active material layer 22B may further include other material such as binding agent, conducting agent, and the like, if necessary. In this negative electrode active material layer 22B, for example, in order to prevent the unintentional deposition of lithium metal when charging and discharging, it is desirable that the charging capacity of the negative electrode material be larger than the discharging capacity of the positive electrode 21. In addition, the binding agent and the conducting agent that can be used in the negative electrode active material layer 22B are the same as those described in the description of the positive electrode 21.

Examples of the negative electrode materials may include carbon materials. This is because the possible changes in crystal structure of such materials in charging or discharging of lithium-ion may be very small, and it makes possible to obtain high charge-discharge capacity and good cycle characteristics. In addition, this is because the carbon material also functions as negative electrode conducting agent. Examples of such carbon materials include graphitizable carbon, non-graphitizable carbon in which a plane spacing of (002) plane is 0.37 nm or more, graphite in which a plane spacing of (002) plane is 0.34 nm or less, and the like. More specifically, pyrolytic carbons, cokes, glassy carbon fiber, baked organic polymer compounds, activated carbon, carbon blacks, and the like may be mentioned. Among such materials, the cokes may include pitch coke, needle coke and petroleum coke, for example. The baked organic polymer compounds represent materials in which a phenolic resin, a furan resin, or the like has been baked at appropriate temperatures and carbonized. In addition, the shape of the carbon material may be any of a fiber shape, a spherical shape, a powder form, or a scale-like shape.

Other than those carbon materials above, examples of the negative electrode materials capable of intercalating and deintercalating lithium, include a material that is capable of intercalating and deintercalating lithium and also having at least one kind of metal element or semimetal element as a constituent element, because it provides a high energy density. Such negative electrode material may be in any form of either or both of metal elements and semimetal elements, such as a single substance, an alloy and a compound, and a material that includes one or more of these forms at least in a portion thereof It should be noted that “alloys” as referred to herein regarding the embodiments of the present disclosure, include those containing two or more kinds of metal elements, and also those containing one or more kinds of metal elements and one or more kinds of semimetal elements. Further, the “alloys” may also contain non-metal elements. Structure of the alloys include a solid solution, a eutectic crystal (eutectic mixture), an intermetallic compound, and coexistence of two or more thereof

Examples of the above-mentioned metal elements and the semimetal elements include a metal element or a semimetal element that is capable of forming an alloy with lithium, and the like. Specifically, such examples of the elements include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd) and platinum (Pt). Among these elements, at least one of silicon and tin is desirable, and silicon would be further desirable. The reason is that such elements have high capability for intercalating and deintercalating lithium, and thereby a high energy density can be achieved.

Examples of negative electrode materials having at least one of silicon and tin include silicon as single substances, alloys and compounds thereof, tin as single substances, alloys and compounds thereof, and materials that include one or more of these forms at least in a portion thereof

Examples of alloys of silicon include an alloy containing, as its second constituent element other than silicon (Si), at least one kind of element selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr). Examples of alloys of tin include an alloy containing, as its second constituent element other than tin (Sn), at least one kind of element selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb) and chromium (Cr).

Examples of compounds of silicon or compounds of tin include a compound that contains either or both of oxygen (0) and carbon (C). Such compound may also contain, in addition to tin or silicon (Si), any of the second constituent elements described above.

In particular, it is desirable that the negative electrode material having at least one of silicon (Si) and tin (Sn) contain, for example, tin (Sn) as its first constituent element, and second and third constituent elements in addition to tin (Sn). Needless to say, this negative electrode material may be used in combination with any of the negative electrode materials described above. The second constituent element is at least one kind of element selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi) and silicon (Si). The third constituent element is at least one kind of element selected from the group consisting of boron (B), carbon (C), aluminum (Al) and phosphorus (P). By using such negative electrode material containing the second and third constituent elements, cycle characteristics can be improved.

Among these materials, the SnCoC-containing material that contains tin (Sn), cobalt (Co) and carbon (C) as constituent elements, in which the content of carbon (C) is 9.9% by mass or more and 29.7% by mass or less and the proportion of cobalt (Co) of the sum of tin (Sn) and cobalt(Co) (Co/(Sn+Co))is 30% by mass or more and 70% by mass or less, would be desirable. The reason is that in such composition range a high energy density and superior cycle characteristics can be achieved.

The SnCoC-containing material may further contain one or more other constituent elements if necessary. These other constituent elements desirably are, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), bismuth (Bi), and the like, and two or more thereof may also be contained. By using them, capacitance characteristics or cycle characteristics can be further improved.

In addition, it is desirable that the SnCoC-containing material have a phase containing tin (Sn), cobalt (Co) and carbon (C), in which the phase has a low crystallized or amorphous structure. Also, in the SnCoC-containing material, it is desirable that at least a part of carbon as the constituent element has been bonded to a metal element or a semimetal element as the other constituent element. The reason is that lowering of cycle characteristics is considered to have been due to aggregation or crystallization of tin (Sn) or the like, and with carbon atoms bonding to other elements, it would be possible to suppress such aggregation or crystallization.

Examples of a measurement method for examining the binding state of elements include X-ray photoelectron spectroscopy (XPS). In this XPS, so far as graphite is concerned, a peak of the is orbit of carbon (Cis) appears at 284.5 eV in an energy-calibrated apparatus such that a peak of the 4f orbit of a gold atom (Au4f) is obtained at 84.0 eV. Also, so far as surface-contaminated carbon is concerned, a peak of the is orbit of carbon (Cis) appears at 284.8 eV. For this, when a charge density of the carbon element is high, for example, when carbon is bonded to a metal element or a semimetal element, the peak of C1s appears in a lower region than 284.5 eV. That is, when a peak of a combined wave of C1s obtained on the SnCoC-containing material appears in a lower region than 284.5 eV, it means that at least a part of carbon (C) contained in the SnCoC-containing material is bonded to a metal element or a semimetal element as other constituent element.

Further, in the XPS measurement, for example, the peak of C1s is used for correcting the energy axis of a spectrum. In most cases, there is some surface-contaminated carbon present in the surface, so the peak of C1s of the surface-contaminated carbon can be fixed at 284.8 eV, and this peak can be used as an energy reference. In the XPS measurement, a waveform of the peak of C1s can be obtained as a form that includes both the peak of the surface-contaminated carbon and the peak of carbon from the SnCoC-containing material, so, for example, through an analysis using commercial software programs, the peak of the surface-contaminated carbon and the peak of the carbon from the SnCoC-containing material can be separated from each other. In the analysis of the waveform, the position of a main peak existing closer to the lowest binding energy is used as an energy reference (284.8 eV).

Also, examples of the negative electrode materials capable of intercalating and deintercalating lithium include metal oxides and polymer compounds, each of which is capable of intercalating and deintercalating lithium. Examples of the metal oxides include, lithium titanium oxide containing lithium and titanium such as lithium titanate (Li₄Ti₅O₁₂), iron oxide, ruthenium oxide and molybdenum oxide. Examples of the polymer compounds include polyacetylene, polyaniline and polypyrrole.

The negative electrode material capable of intercalating and deintercalating lithium may further include those other than the above. Further, the negative electrode materials mentioned above may also be mixed in any combination of two or more.

The negative electrode active material layer 22B may be, for example, formed by any of a vapor phase method, a liquid phase method, a spraying method, a baking method or a coating method, or a combined method of two or more kinds of these methods. When the negative electrode active material layer 22B is formed by using a vapor phase method, a liquid phase method, a spraying method, a baking method or a combined method of two or more kinds of these methods, it is desirable that the negative electrode active material layer 22B and the negative electrode current collector 22A would be alloyed on at least a part of an interface therebetween. Specifically, it is desirable that on the interface, constituent element of the negative electrode current collector 22A would be diffused into the negative electrode active material layer 22B, the constituent element of the negative electrode active material layer 22B would be diffused into the negative electrode current collector 22A, or these constituent elements would be diffused into each other. The reason is that the breakage due to expansion and shrinkage, following the charging and discharging, of the negative electrode active material layer 22B can be suppressed, and also that electron conductivity between the negative electrode active material layer 22B and the negative electrode current collector 22A can be improved.

Examples of the vapor phase method include a physical deposition method and a chemical deposition method, specifically a vacuum vapor deposition method, a sputtering method, an ion plating method, a laser abrasion method, a thermal chemical vapor deposition (CVD) method and a plasma chemical vapor deposition method. As the liquid phase method, known techniques such as electrolytic plating and electroless plating can be used. The baking method as referred to herein is, for example, a method in which after a particulate negative electrode active material is mixed with a binding agent and the like, the mixture is dispersed in a solvent and coated, and the coated material is then heated at a higher temperature than a melting point of the binding agent or the like. As to the baking method, known techniques can be also utilized, and examples thereof include an atmospheric baking method, a reaction baking method and a hot press baking method.

[Separator]

The separator 23 is configured to separate the positive electrode 21 and the negative electrode 22, preventing electric short-circuit and allowing the passage of lithium-ion. The separator 23 is configured to include, for example, a porous film made of synthetic resins such as polytetrafluoroethylene, polypropylene and polyethylene, or a porous film made of ceramic, or the like. The separator 23 may also include two or more of the above-mentioned porous films that has been laminated. This separator 23 is impregnated with an electrolyte solution, which is an electrolyte in the form of a liquid.

[Electrolyte Solution]

The electrolyte solution contains a solvent and an electrolytic salt. This electrolyte solution is an electrolyte which is an ion conductor, and for example, is a non-aqueous electrolyte solution of an electrolytic salt dissolved in a non-aqueous solvent.

[Solvent]

Examples of the solvents include non-aqueous solvents such as ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyrane, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide.

The solvent described listed above can be used either as one kind thereof or in combination of two or more if necessary. Among these solvents, at least one kind of solvent selected from the group consisting of ethylene carbonate, propylene carbonate, dimethyl carbonate, diethyl carbonate and ethyl methyl carbonate would be desirable. In this case, a combination of, a thick solvent (with high permittivity, for example, with relative permittivity of ε≧30) such as ethylene carbonate and propylene carbonate; and a thin solvent (for example, with viscosity of 1 [mPa·s] or less) such as dimethyl carbonate, ethyl methyl carbonate and diethyl carbonate; would be further desirable. This is because the electrolysis-ness of electrolytic salts and the mobility of ions would be improved.

[Electrolytic Salt]

As the electrolytic salt, for example, any one or more kinds of light metal salts such as lithium salts can be used.

Examples of lithium salts include lithium hexafluorophosphate (LiPF₆), lithium tetrafluoroborate, lithium perchlorate, lithium hexafluoroarsenate, lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCo₄), dilithiumhexafluorosilicate (Li₂SiF₆), lithium chloride (LiCl) and lithium bromide (LiBr). The electrolytic salt described listed above can be used either as one kind thereof or in combination of two or more if necessary.

[Manufacturing Method of Battery]

The secondary battery is, for example, manufactured by the following method.

[Manufacture of Positive Electrode]

First of all, the positive electrode 21 is fabricated. First, a positive electrode material, a binding agent and a conducting agent are mixed to form a positive electrode mixture, which is then dispersed in an organic solvent to form positive electrode mixture slurry in a paste form. Subsequently, the positive electrode mixture slurry is uniformly coated on both surfaces of the positive electrode current collector 21A by a doctor blade or a bar coater or the like and then dried. Finally, the coating is subjected to compression molding by a roll press or the like, with heating if necessary, thereby forming the positive electrode active material layer 21B. In that case, the compression molding may be repeatedly carried out plural times.

[Manufacture of Negative Electrode]

Next, the negative electrode 22 is fabricated. First, a negative electrode material and a binding agent and optionally, a conductive agent are mixed to form a negative electrode mixture, which is then dispersed in an organic solvent to form negative electrode mixture slurry in a paste form. Subsequently, the negative electrode mixture slurry is uniformly coated on both surfaces of the negative electrode current collector 22A by a doctor blade or a bar coater or the like and then dried. Finally, the coating is subjected to compression molding by a roll press or the like, with heating if necessary, thereby forming the negative electrode active material layer 22B.

It should be noted that the negative electrode 22 may be manufactured also in the following way. First, the negative electrode current collector 22A which include electrolytic copper foil or the like is prepared, and then by vapor phase method such as vapor deposition method, the negative electrode material is deposited on both surfaces of the negative electrode current collector 22A, thereby forming a plurality of negative electrode active material particles. After this, if necessary, forming an oxide-containing coating by liquid phase method such as liquid phase deposition; forming a metallic substance by liquid phase method such as electrolytic plating; or forming both of the above, the negative electrode active material layer 22B can be formed.

[Fabrication of Center Pin]

A center pin material with a plate shape stamped out in a predetermined shape is prepared, and the center pin material is rolled into a cylindrical shape. Alternatively, a pipe of the center pin material with a tubular shape may be cut. Subsequently, both ends thereof are tapered to provide the taper portions 24b. The cut-out portions 24c in the tip end portion of the center pin 24 are fabricated together when stamping out into the plate shape. Alternatively, they may be fabricated by cutting the tip end thereof by a predetermined shape when processing tapering in the both ends.

[Assembly of Battery]

The secondary battery is assembled in the following manner. First, the positive electrode lead 25 is installed in the positive electrode current collector 21A by welding or the like, and the negative electrode lead 26 is installed in the negative electrode current collector 22A by welding or the like. Then, the positive electrode 21 and the negative electrode 22 are spirally wound via the separator 23 to form the spirally wound electrode body 20.

Next, the center pin 24 is inserted into the center of the spirally wound electrode body 20. Subsequently, the spirally wound electrode body 20 is sandwiched by the pair of insulating plates 12 and 13. Then, the negative electrode lead 26 is welded to the can bottom of the battery can 11, and the positive electrode lead 25 is welded to the contact plate 34. Next, the spirally wound electrode body 20 is housed inside the battery can 11, the electrolyte solution is injected into the battery can 11, and the separator 23 is impregnated with the electrolyte solution. Finally, the battery cover 14, the safety valve 15, and the PTC device 16 are fixed at the open end portion of the battery can 11 by being caulked with the gasket 17. The secondary battery shown in FIGS. 1 to 3 is thus completed.

According to the battery of the embodiment of the present disclosure, with the use of the center pin 24 which has the plurality of the cut-out portions 24c provided in the tip end of the center pin 24 (taper portion 24b), even when the tip end of the center pin 24 and the battery cover 14 come into contact during the gas ejection, the gas is released to the side from the cut-out portions 24c. Thus, the gas at the bottom portion side of the battery is externally released smoothly, so this has the effect of relieving the momentum of the gas ejection. Therefore, by the battery having the center pin 24 of the embodiment of the present disclosure showing little or no battery cell movement even when the gas is ejected in the case of such as when it is thrown into the fire, it is possible to terminate the gas ejection safely and make it inactivated.

Specifically, regarding recent batteries with improved charge-discharge capacity, the diameter of the center pin has been reduced in order to increase the amount of the active material filled into the battery. The inner diameter of the taper portion provided at the end of the center pin has become increasingly smaller, which decreases its function as the gas releasing path, thus it has become very difficult to achieve both safety and increased capacity of the battery. In response to this, by using the center pin 24 of the embodiment of the present disclosure having a simple structure as described above, it is possible to realize the practical application of the battery having high safety with less moving distance when the gas is ejected, while having high battery capacity. This industrial value is very high.

In the future, the embodiment of the present disclosure may be not only a technique of improving the battery capacity that enables reducing the diameter of the center pin 24 but also an indispensable technique for ensuring safety when being used in vehicles or large apparatus. Furthermore, the non-aqueous electrolyte secondary battery having such structurally superior center pin 24 of the embodiment of the present disclosure is a battery with superior safety. The non-aqueous electrolyte secondary battery of the embodiment of the present disclosure which realized superior performance in this manner would contribute significantly to the development of the industry related to portable electronic apparatus.

### 2. Second Embodiment

[Example of Battery Pack]

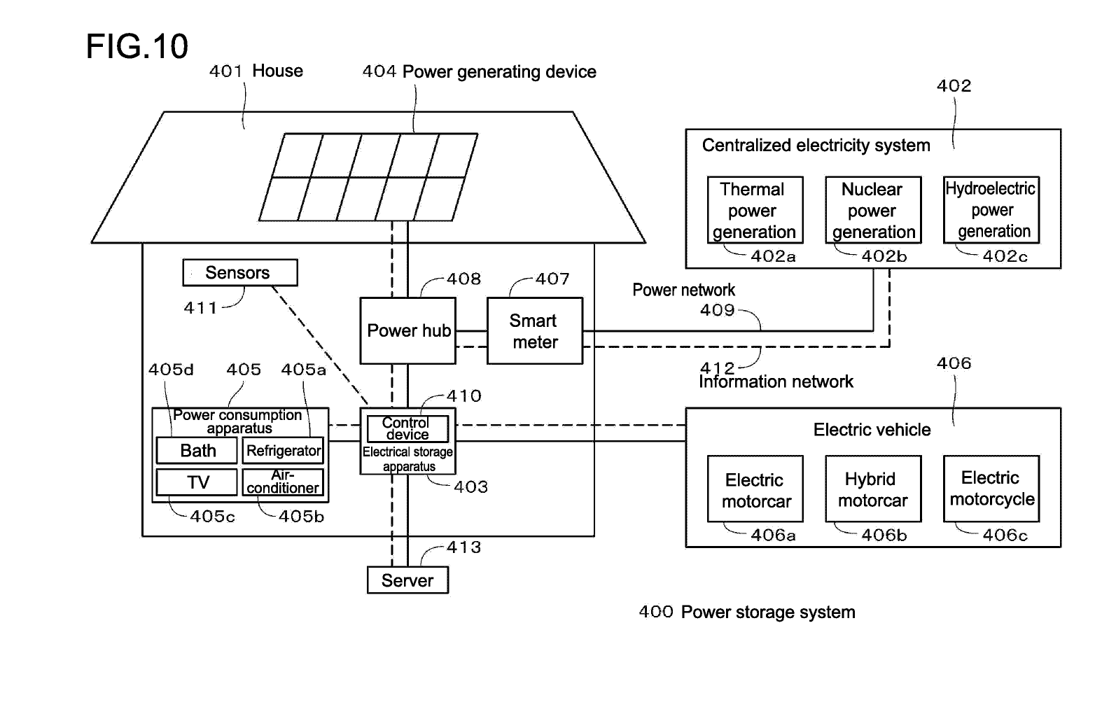

FIG. 9 is a block diagram showing a circuit configuration example of a case where a secondary battery of an embodiment of the present disclosure is applied to a battery pack. The battery pack includes an assembled battery 301, an exterior, a switch unit 304 having a charge control switch 302a and a discharge control switch 303a, a current sensing resistor 307, a temperature sensing device 308, and a control unit 310.

Further, the battery pack includes a positive terminal 321 and a negative terminal 322. In charging, the positive terminal 321 and the negative terminal 322 are connected to a positive terminal and a negative terminal of a charger, respectively, and the charging is carried out. On the other hand, when using an electronic apparatus, the positive terminal 321 and the negative terminal 322 are connected to a positive terminal and a negative terminal of the apparatus, respectively, and the discharge is carried out.

The assembled battery 301 is configured with a plurality of the secondary batteries 301a connected to one another in series and/or in parallel. The secondary battery 301a is a secondary battery of an embodiment of the present disclosure. It should be noted that although there is shown in FIG. 9 a case where the six secondary batteries 301a are connected in two batteries in parallel and three in series (2P3S configuration) as an example, also others, such as n in parallel and m in series (where n and m are integers), and any way of connections may be adopted.

The switch unit 304 includes a charge control switch 302a and a diode 302b, and a discharge control switch 303a and a diode 303b and is controlled by a control unit 310. The diode 302b has the polarity in opposite direction with respect to charge current flowing from the positive terminal 321 to the assembled battery 301 and in forward direction with respect to discharge current flowing from the negative terminal 322 to the assembled battery 301. The diode 303b has the polarity in forward direction with respect to the charge current and in opposite direction with respect to the discharge current. It should be noted that although in this example the switch unit is provided on the positive terminal side, it may otherwise be provided on the negative terminal side.

The charge control switch 302a is configured to be turned off in the case where a battery voltage reaches an overcharge detection voltage, and it is controlled by the control unit 310 such that the charge current does not flow in a current path of the assembled battery 301. After the charge control switch 302a is turned off, only discharge can be performed via the diode 302b. Further, in the case where a large amount of current flows at a time of charge, the charge control switch 302a is turned off and is controlled by the control unit 310 such that the charge current flowing in the current path of the assembled battery 301 is shut off

The discharge control switch 303a is configured to be turned off in the case where a battery voltage reaches an overdischarge detection voltage, and it is controlled by the control unit 310 such that the discharge current does not flow in a current path of the assembled battery 301. After the discharge control switch 303a is turned off, only charge can be performed via the diode 303b. Further, in the case where a large amount of current flows at a time of discharge, the discharge control switch 303a is turned off and is controlled by the control unit 310 such that the discharge current flowing in the current path of the assembled battery 301 is shut off

A temperature sensing device 308 is a thermistor, for example, provided in the vicinity of the assembled battery 301. The temperature sensing device 308 is configured to measure a temperature of the assembled battery 301 and supply the measured temperature to the control unit 310. A voltage detection unit 311 is configured to measure voltages of the assembled battery 301 and each of the secondary batteries 301a included in the assembled battery 301, then A/D-convert the measured voltages, and supply them to the control unit 310. A current measurement unit 313 is configured to measure a current using a current detection resistor 307 and supply the measured current to the control unit 310.

The switch control unit 314 is configured to control the charge control switch 302a and the discharge control switch 303a of the switch unit 304 on the basis of the voltage and the current that are input from the voltage detection unit 311 and the current measurement unit 313. The switch control unit 314 is configured to transmit a control signal of the switch unit 304 when a voltage of any one of secondary batteries 301a reaches the overcharge detection voltage or less or the overdischarge detection voltage or less, or, a large amount of current flows rapidly, in order to prevent overcharge, overdischarge, and over-current charge and discharge.

Here, in the case where the secondary battery is a lithium-ion secondary battery, an overcharge detection voltage is defined to be 4.20 V±0.05 V, for example, and an overdischarge detection voltage is defined to be 2.4 V±0.1 V, for example.

For a charge and discharge control switch, a semiconductor switch such as a MOSFET (metal-oxide semiconductor field-effect transistor) can be used. In this case, parasitic diodes of the MOSFET function as the diodes 302b and 303b. In the case where p-channel FETs (field-effect transistors) are used as the charge and discharge control switch, the switch control unit 314 supplies a control signal DO and a control signal CO to a gate of the charge control switch 302a and that of the discharge control switch 303a, respectively. In the case where the charge control switch 302a and the discharge control switch 303a are of p-channel type, the charge control switch 302a and the discharge control switch 303a are turned on by a gate potential lower than a source potential by a predetermined value or more. In other words, in normal charge and discharge operations, the control signals CO and DO are determined to be a low level and the charge control switch 302a and the discharge control switch 303a are turned on.

Further, for example, when overcharged or overdischarged, the control signals CO and DO are determined to be a high level and the charge control switch 302a and the discharge control switch 303a are turned off

A memory 317 includes a RAM (random access memory), a ROM (read only memory), an EPROM (erasable programmable read only memory) serving as a nonvolatile memory, or the like. In the memory 317, numerical values computed by the control unit 310, an internal resistance value of a battery in an initial state of each secondary battery 301a, which has been measured in a stage of a manufacturing process, and the like are stored in advance, and can be rewritten as appropriate. Further, when a full charge capacity of the secondary battery 301a is stored, for example, a remaining capacity can be calculated together with the control unit 310.

A temperature detection unit 318 is provided, to measure the temperature using the temperature sensing device 308 and control charging or discharging when abnormal heat generation has occurred, or perform correction in calculation of the remaining capacity.

### 3. Third Embodiment

The above-mentioned secondary battery and the battery pack using the same can be installed or be used in providing electricity to apparatus such as electronic apparatus, electric vehicle and electrical storage apparatus, for example.

Examples of electronic apparatus are laptops, PDA (Personal Digital Assistant), cellular phones, cordless telephone handset, video movies, digital still cameras, electronic books, electronic dictionaries, music players, radio, headphones, game machine, navigation system, memory cards, pacemakers, hearing aids, electric tools, electric shavers, refrigerator, air-conditioner, televisions, stereos, water heater, microwave oven, dishwasher, washing machine, dryer, lighting equipments, toys, medical equipments, robots, load conditioners, traffic lights, and the like.

Examples of electric vehicles are railway vehicles, golf carts, electric carts, electric motorcars (including hybrid motorcars), and the like. The above-mentioned embodiments would be used as their driving power source or auxiliary power source.

Examples of electrical storage apparatus include power sources for electrical storage to be used by power generation facilities or buildings such as houses.

Among examples of application mentioned in the above, a specific example of power storage system which has adopted a secondary battery in embodiments of the present disclosure will be described below.

The power storage system may employ the following configurations, for example. A first power storage system is a power storage system having an electrical storage apparatus configured to be charged by a power generating device that generates electricity from renewable energy. A second power storage system has an electrical storage apparatus, and is configured to provide electricity to an electronic apparatus connected to the electrical storage apparatus. A third power storage system is a configuration of an electronic apparatus in such a way as to receive electricity supply from an electrical storage apparatus. These power storage systems are realized as a system in order to supply electricity efficiently in cooperation with an external power supply network.

Furthermore, a fourth power storage system is a configuration of an electric vehicle, including a converter configured to receive electricity supply from an electrical storage apparatus and convert the electricity into driving force for vehicle, and further including a controller configured to process information on vehicle control on the basis of information on the electrical storage apparatus. A fifth power storage system is an electricity system including an electricity information transmitting-receiving unit configured to transmit and receive signals via a network to and from other apparatuses, in order to control the charge and discharge of the above-mentioned electrical storage apparatus on the basis of information received by the transmitting-receiving unit. The sixth power storage system is an electricity system configured to receive electricity supply from the above-mentioned electrical storage apparatus or provide the electrical storage apparatus with electricity from at least one of a power generating device and a power network. The power storage system is described below.

3-1.) Power Storage System for Houses as Application Example

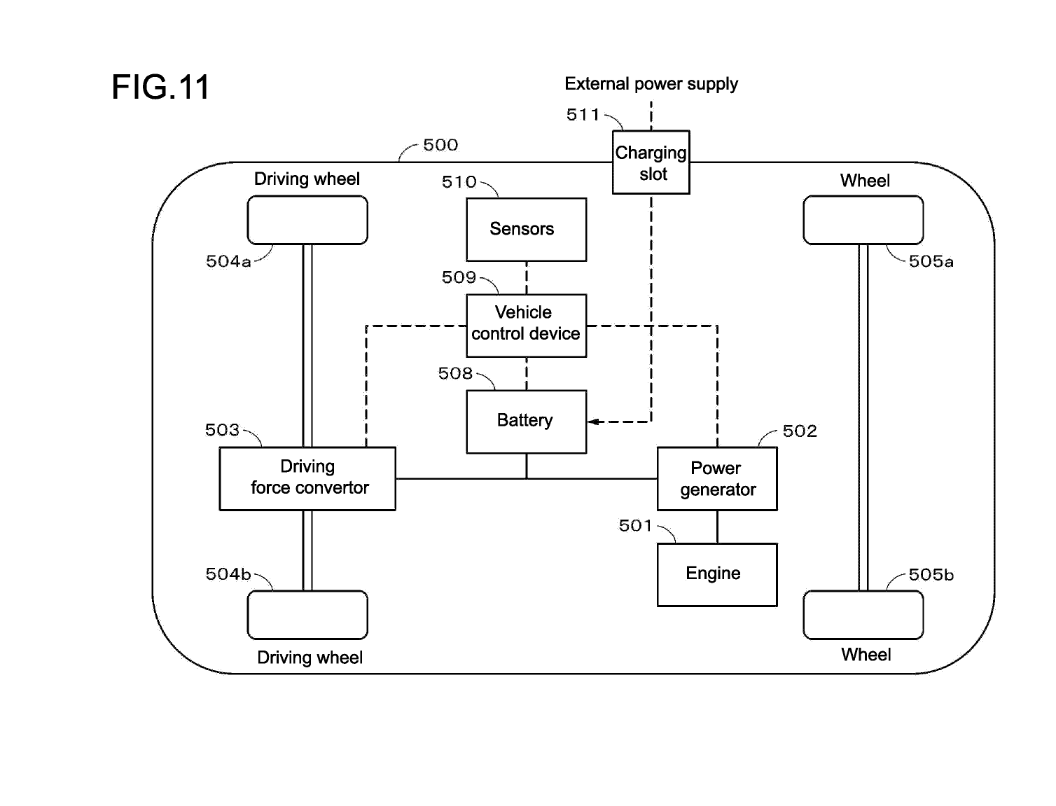

An example of a case where electrical storage apparatus using the secondary battery of an embodiment of the present disclosure is applied to power storage system for houses will be described with reference to FIG. 10. For example, in power storage system 400 for a house 401, electricity is provided to an electrical storage apparatus 403 from a centralized electricity system 402 including thermal power generation 402a, nuclear power generation 402b, hydroelectric power generation 402c and the like via power network 409, information network 412, smart meter 407, power hub 408 and the like. Along with this, from independent power source such as in-house power generating device 404, electricity is also provided to the electrical storage apparatus 403. Therefore, electricity given to the electrical storage apparatus 403 is stored. By using the electrical storage apparatus 403, electricity to be used in the house 401 can be supplied. Not only for a house 401, but also with respect to other buildings, similar power storage system can be applied.

The house 401 is provided with the power generating device 404, a power consumption apparatus 405, an electrical storage apparatus 403, a control device 410 that controls each device or apparatus, a smart meter 407, and sensors 411 that obtain various kinds of information. The devices or apparatus are connected to one another through the power network 409 and the information network 412. For the power generating device 404, a solar battery, a fuel battery, or the like is used, and the generated electricity is supplied to the power consumption apparatus 405 and/or the electrical storage apparatus 403. Examples of the power consumption apparatus 405 include a refrigerator 405a, an air-conditioner 405b, a television receiver 405c, and a bath 405d. In addition, the power consumption apparatus 405 includes an electric vehicle 406. Examples of the electric vehicle 406 include an electric motorcar 406a, a hybrid motorcar 406b, and an electric motorcycle 406c.

The above-mentioned secondary battery of an embodiment of the present disclosure is applied to the electrical storage apparatus 403. The secondary battery of an embodiment of the present disclosure may be, for example, configured by a lithium-ion secondary battery. The smart meter 407 has functions of measuring the used amount of commercial electricity and transmitting the measured used amount to an electricity company. The power network 409 may be any one of DC power feeding, AC power feeding, and noncontact supply of electricity, or may be such that two or more of them are combined.

Examples of various sensors 411 include a human detection sensor, an illumination sensor, an object detection sensor, a power consumption sensor, a vibration sensor, a contact sensor, a temperature sensor and an infrared sensor. The information obtained by the various sensors 411 is transmitted to the control device 410. The state of the weather conditions, the state of a person, and the like are understood on the basis of the information from the sensors 411, and the power consumption apparatus 405 can be automatically controlled to minimize energy consumption. In addition, it is possible for the control device 410 to transmit information on the house 401 to an external electricity company and the like through the Internet.

Processing, such as branching of electricity lines and DC/AC conversion, is performed by using a power hub 408. Examples of a communication scheme for an information network 412 that is connected with the control device 410 include a method of using a communication interface, such as UART (Universal Asynchronous Receiver-Transceiver: transmission and reception circuit for asynchronous serial communication), and a method of using a sensor network based on a wireless communication standard, such as Bluetooth (registered trade name), ZigBee, and WiFi. The Bluetooth method can be applied to multimedia communication, so that one-to-many connection communication can be performed. ZigBee uses the physical layer of IEEE (Institute of Electrical and Electronics Engineers) 802.15.4. IEEE 802.15.4 is the title of the short-distance wireless network standard called personal area network (PAN) or wireless (W) PAN.

The control device 410 is connected to an external server 413. The server 413 may be managed by one of the house 401, an electricity company, and a service provider. The information that is transmitted and received by the server 413 is, for example, information on power consumption information, life pattern information, an electricity fee, weather information, natural disaster information, and electricity transaction. These pieces of information may be transmitted and received from a power consumption apparatus (for example, television receiver) inside a household. Alternatively, the pieces of information may be transmitted and received from an out-of-home device (for example, a mobile phone, etc.). These pieces of information may be displayed on a device having a display function, for example, a television receiver, a mobile phone, or a personal digital assistant (PDA).

The control device 410 that controls each unit includes central processing unit (CPU), a random access memory (RAM), a read only memory (ROM), and the like. In this example, the control device 410 is stored in the electrical storage apparatus 403. The control device 410 is connected to the electrical storage apparatus 403, the in-house power generating device 404, the power consumption apparatus 405, the various sensors 411, and the server 413 through the information network 412, and has functions of adjusting the use amount of the commercial electricity, and the amount of power generation. In addition, the control device 410 may have a function of performing electricity transaction in the electricity market.

As described above, not only the centralized electricity system 402 in which electricity comes from thermal power generation 402a, nuclear power generation 402b, hydroelectric power generation 402c, or the like, but also the generated electricity from the in-house power generating device 404 (solar power generation, wind power generation) can be stored in the electrical storage apparatus 403. Therefore, even if the generated electricity of the in-house power generating device 404 varies, it is possible to perform control such that the amount of electricity to be sent to the outside is made constant or electric discharge is performed by only a necessary amount. For example, usage is possible in which electricity obtained by the solar power generation is stored in the electrical storage apparatus 403, late night power whose fee is low during nighttime is stored in the electrical storage apparatus 403, and the electricity stored by the electrical storage apparatus 403 is discharged and used in a time zone in which the fee during daytime is high.

In this example, an example has been described in which the control device 410 is stored in the electrical storage apparatus 403. Alternatively, the control device 410 may be stored in the smart meter 407 or may be configured singly. In addition, the power storage system 400 may be used by targeting a plurality of households in a block of apartments or may be used by targeting a plurality of single-family detached houses.

3-2.) Power Storage System for Vehicles as Application Example

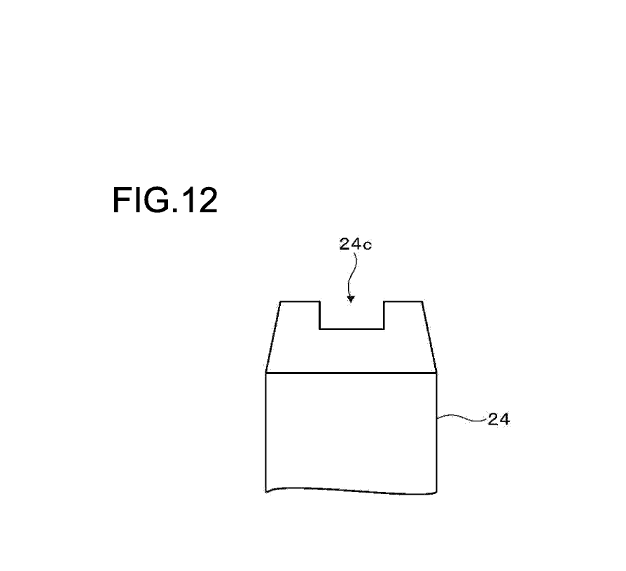

An example of a case where an embodiment of the present disclosure is applied to a power storage system for vehicles will be described with reference to FIG. 11. FIG. 11 schematically shows an example of configuration of a hybrid vehicle employing series-hybrid system, in which an embodiment of the present disclosure is applied. A series-hybrid system is a car that runs using electricity driving force converter by using electricity generated by a power generator that is driven by an engine or by using electricity that is temporarily stored in a battery.

A hybrid vehicle 500 is equipped with an engine 501, a power generator 502, an electricity driving force converter 503, a driving wheel 504a, a driving wheel 504b, a wheel 505a, a wheel 505b, a battery 508, a vehicle control device 509, various sensors 510, and a charging slot 511. The above-mentioned secondary battery of an embodiment of the present disclosure is applied to the battery 508.

The hybrid vehicle 500 runs by using the electricity driving force converter 503 as a power source. An example of the electricity driving force converter 503 is a motor. The electricity driving force converter 503 operates using the electricity of the battery 508, and the rotational force of the electricity driving force converter 503 is transferred to the driving wheels 504a and 504b. By using direct current-alternating current (DC-AC) or inverse conversion (AC-DC conversion) at a necessary place, the electricity driving force converter 503 can use any of an AC motor and a DC motor. The various sensors 510 are configured to control the engine revolution speed through the vehicle control device 509 or control the opening (throttle opening) of a throttle valve, although not shown in the drawing. The various sensors 510 include a speed sensor, an acceleration sensor, an engine revolution speed sensor, and the like.

The rotational force of the engine 501 is transferred to the power generator 502, and the electricity generated by the power generator 502 by using the rotational force can be stored in the battery 508.

When a hybrid vehicle 500 decelerates by a braking mechanism, although not shown in the drawing, the resistance force at the time of the deceleration is added as a rotational force to the electricity driving force converter 503. The regenerative electricity generated by the electricity driving force converter 503 by using the rotational force can be stored in the battery 508.

The battery 508, as a result of being connected to an external power supply of the hybrid vehicle 500, receives supply of electricity by using a charging slot 511 as an input slot from the external power supply, and can store the received electricity.

Although not shown in the drawing, the embodiment of the present disclosure may include an information processing device that performs information processing for vehicle control on the basis of information on a secondary battery. Examples of such information processing devices include an information processing device that performs display of the remaining amount of a battery on the basis of the information on the remaining amount of the battery.

In the foregoing, a description has been made referring to an example of a series-hybrid car that runs using a motor by using electricity generated by a power generator that is driven by an engine or by using electricity that had once been stored in a battery. However, the embodiment according to the present disclosure can be effectively applied to a parallel hybrid car in which the outputs of both the engine and the motor are used as a driving source and in which switching between three methods, that is, running using only an engine, running using only a motor, and running using an engine and a motor, is performed as appropriate. In addition, the embodiment according to the present disclosure can be effectively applied to a so-called motor-driven vehicle that runs by driving using only a driving motor without using an engine.

### EXAMPLES

Specific Examples of the embodiments of the present disclosure will be described in detail, but it should not be construed that the present invention is limited only to these Examples.

### Example 1-1

(Fabrication of Positive Electrode)

First of all, lithium cobalt oxide (LiCoO2) was used as the positive electrode active material. Ninety-four parts by mass of this lithium cobalt oxide, three parts by mass of graphite as the conducting agent and three parts by mass of polyvinylidene fluoride as the binding agent were uniformly mixed to prepare the positive electrode mixture. Subsequently, the positive electrode mixture was dispersed in N-methyl-2-pyrrolidone to provide the positive electrode mixture slurry. This positive electrode mixture slurry was uniformly coated on the both surfaces of a foil of aluminum (Al) which would be the positive electrode current collector, was dried under reduced pressure for 24 hours at 100° C., and then was subjected to compression molding by a roll press to form the positive electrode active material layer. After this, a positive electrode terminal made of aluminum (Al) was connected to an exposed part of the positive electrode current collector.

(Fabrication of Negative Electrode)

In addition, a pulverized graphite powder was used as the negative electrode active material. Ninety parts by weight of this graphite powder and ten parts by mass of polyvinylidene fluoride as the binding agent were uniformly mixed to prepare the negative electrode mixture. Subsequently, the negative electrode mixture was dispersed in N-methyl-2-pyrrolidone to provide the negative electrode mixture slurry. This negative electrode mixture slurry was uniformly coated on the both surfaces of a foil of copper (Cu) which would be the negative electrode current collector, was dried under reduced pressure for 24 hours at 120° C., and then was subjected to compression molding by a roll press to form the negative electrode active material layer. After this, a negative electrode terminal made of nickel (Ni) was connected to a part at the tip end of the negative electrode current collector where the negative electrode active material layer was not formed.

(Fabrication of Center Pin)

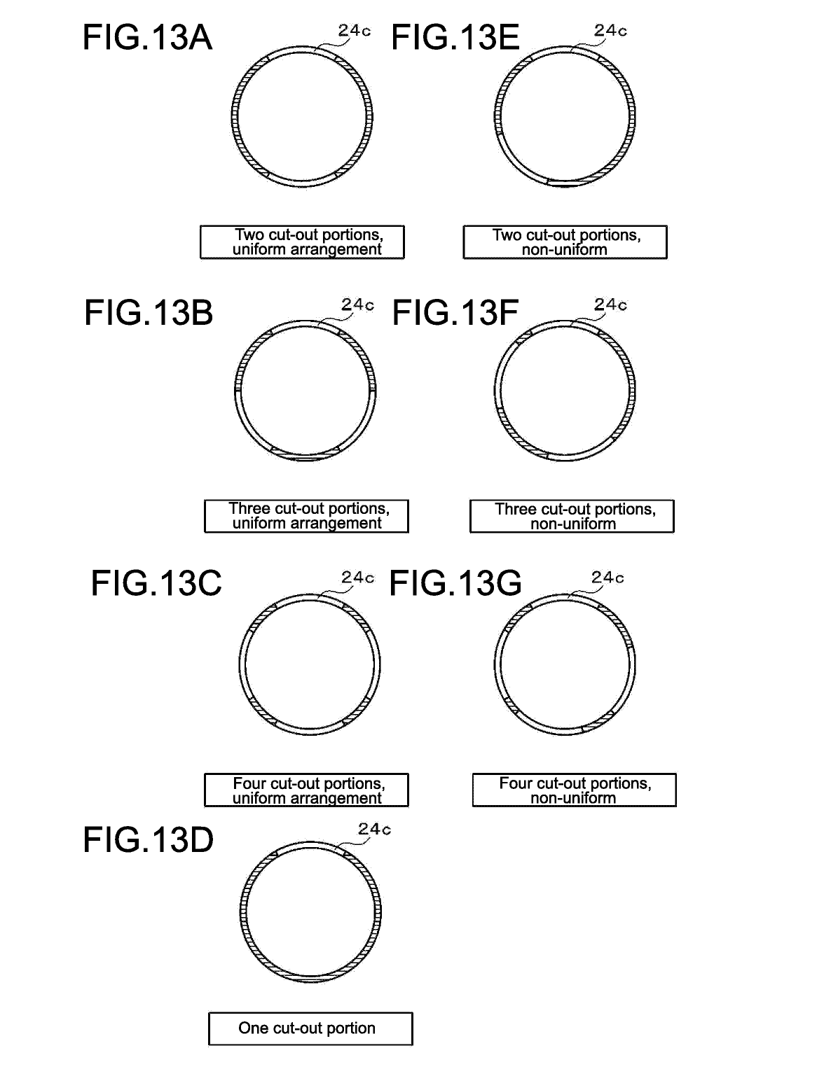

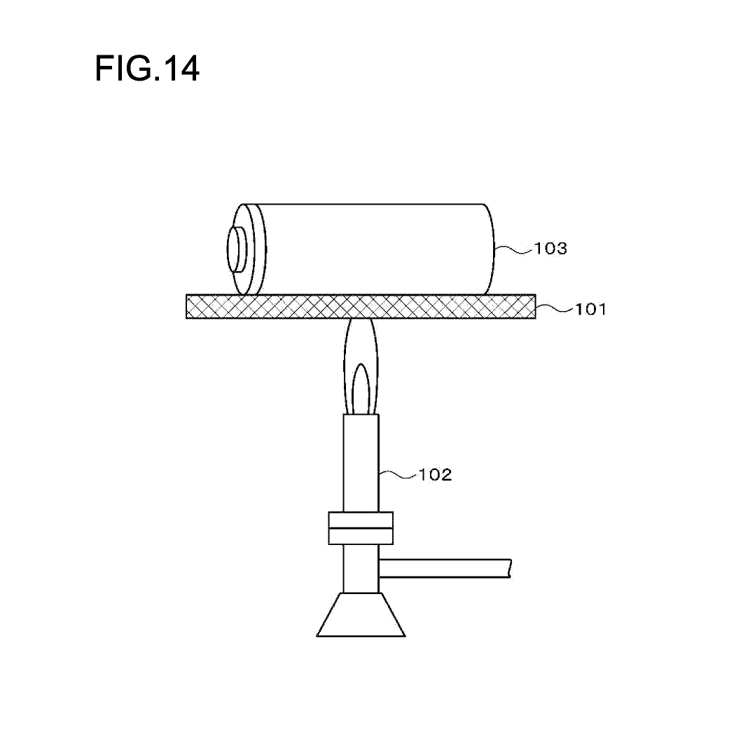

The cylinder-shaped center pin having a hollow structure provided with the taper portions at the both end portions was fabricated. The outer diameter of the center pin was 2.8 mm, the inner periphery of the tip end provided with the taper portion (the diameter of the center pin tip end portion) was 2.3 mm and the length of the inner periphery of the tip end provided with the taper portion (inner peripheral length of the tip end of the center pin) was 7.23 mm. The constituent material of the center pin was a stainless steel (0.1 mm thick) plated with nickel (Ni). The length of the taper portion was 1 mm. In the tip end of the taper portions provided at the both end portions, two cut-out portions of the rectangular shape shown in FIG. 12 were provided in a substantially uniform arrangement in which the intervals between the cut-out portions are substantially equal with each other, as shown in FIG. 13A. The width of this cut-out portion was set to 0.5 mm, and the depth of the cut-out portion was set to 0.5 mm.

(Assembly of Cylindrical Battery)

Subsequently, the separator made of microporous polypropylene film was prepared. The positive electrode, the separator, the negative electrode and the separator were laminated in this order and then were spirally wound multiple times to fabricate the spirally wound electrode body. After this, the center pin was inserted into the center of the spirally wound electrode body. The positive electrode lead was joined to the safety valve which was joined with the battery cover, and the negative electrode lead was joined to the battery can. The spirally wound electrode body was sandwiched between the pair of insulating plates, and was housed inside the battery can.

Next, the electrolyte solution was injected into the battery can from above the insulating plate. As the electrolyte solution, there was used a solution obtained by dissolving LiPF6 as the electrolytic salt at the content of 1 mol/l in the solvent in which ethylene carbonate (EC) and diethyl carbonate (DEC) were mixed in an equal mass ratio. Subsequently, at the open portion of the battery can, the safety valve, the PTC device and the battery cover were fixed by being caulked with the gasket to fabricate a so-called 18650 size cylindrical battery.

### Example 1-2

In the tip end of the taper portions provided at the both end portions of the center pin, three cut-out portions of the rectangular shape shown in FIG. 12 were provided in a substantially uniform arrangement in which the intervals among the cut-out portions are substantially equal from one another, as shown in FIG. 13B. The width and the depth of each cut-out portion were the same as Example 1-1. Except for the above, a cylindrical battery was fabricated in the same manner as in Example 1-1.

### Example 1-3

In the tip end of the taper portions provided at the both end portions of the center pin, four cut-out portions of the rectangular shape shown in FIG. 12 were provided in a substantially uniform arrangement in which the intervals among the cut-out portions are substantially equal from one another, as shown in FIG. 13C. The width and the depth of each cut-out portion were the same as Example 1-1. Except for the above, a cylindrical battery was fabricated in the same manner as in Example 1-1.

### Comparative Example 1-1

In the tip end of the taper portions provided at the both end portions of the center pin, it was not provided with the cut-out portions. Except for the above, a cylindrical battery was fabricated in the same manner as in Example 1-1.

### Comparative Example 1-2

In the tip end of the taper portions provided at the both end portions of the center pin, one cut-out portion of the rectangular shape shown in FIG. 12 was provided by the arrangement shown in FIG. 13D. The width and the depth of the cut-out portion were the same as Example 1-1. Except for the above, a cylindrical battery was fabricated in the same manner as in Example 1-1.

[Evaluations]

(Fire Test)

Each of the thus-fabricated batteries of Examples and Comparative Examples was placed on top of a wire net 101. The central part of the battery 103 was heated by a gas burner 102 from the underneath of the battery 103. The test was performed on five batteries for each of Examples and Comparative Examples, to check whether or not the battery 103 was moved from the top of the wire net 101 by the gas ejection. In addition, in the case where the battery 103 was moved from the top of the wire net 101, the moving distance was measured, and was determined whether or not the moving distance was within 0.7 meters. The 0.7 meters is a criterion value prescribed in order to meet the safety requirement regarding lithium ion secondary batteries for consumer use.

The test results of Examples 1-1 to 1-3 and Comparative Examples 1-1 and 1-2 are shown in Table 1.

TABLE 1

| | | | | The | | | | | |
|---|---|---|---|---|---|---|---|---|---|
| | Center pin tip end portion | | Presence | number | | | | | |
| | Shape of cut- | | of cut-out | of cut-out | | | | | |
| | out portion(s) | Arrangement | portion(s) | portion(s) | Battery 1 | Battery 2 | Battery 3 | Battery 4 | Battery 5 |
| Ex. 1-1 | Rectangular | FIG. 13A | Yes | 2 | Moved | Not | Not | Not | Not |
| | (FIG. 12) | | | | 0.5 m | moved | moved | moved | moved |
| Ex. 1-2 | Rectangular | FIG. 13B | Yes | 3 | Moved | Not | Not | Not | Not |
| | (FIG. 12) | | | | 0.1 m | moved | moved | moved | moved |
| Ex. 1-3 | Rectangular | FIG. 13C | Yes | 4 | Not | Not | Not | Not | Not |
| | (FIG. 12) | | | | moved | moved | moved | moved | moved |
| Comp. Ex. | — | — | No | None | Moved | Moved | Moved | Not | Not |
| 1-1 | | | | | 1 m | 2 m | 3 m | moved | moved |
| Comp. Ex. | Rectangular | FIG. 13D | Yes | 1 | Moved | Moved | Not | Not | Not |
| 1-2 | (FIG. 12) | | | | 1 m | 2 m | moved | moved | moved |

As shown in Table 1, in Examples 1-1 to 1-3, the battery structure was provided with two or more cut-out portions in the end portion of the center pin. As a result, in the fire test, there was no battery movement, or even if the battery was moved, the moving distance was within 0.7 meters. On the other hand, in Comparative Examples 1-1 and 1-2, there was a battery movement of the moving distance greater than 0.7 meters.

### Example 2-1

In the tip end of the taper portions provided at the both end portions of the center pin, two cut-out portions of the rectangular shape shown in FIG. 12 were provided in a substantially uniform arrangement in which the intervals between the cut-out portions are substantially equal with each other, as shown in FIG. 13A. The width of each cut-out portion was set to the length of 5% as the ratio to the inner peripheral length of the tip end of the center pin. The depth of each cut-out portion was set to the length of 50% as the ratio to the length of the taper portion. The total width ratio of the cut-out portions was 10%. Except for the above, a cylindrical battery was fabricated in the same manner as in Example 1-1.

### Example 2-2

In the tip end of the taper portions provided at the both end portions of the center pin, two cut-out portions of the rectangular shape shown in FIG. 12 were provided in a substantially uniform arrangement in which the intervals between the cut-out portions are substantially equal with each other, as shown in FIG. 13A. The width of each cut-out portion was set to the length of 30% as the ratio to the inner peripheral length of the tip end of the center pin. The depth of each cut-out portion was set to the length of 50% as the ratio to the length of the taper portion. The total width ratio of the cut-out portions was 60%. Except for the above, a cylindrical battery was fabricated in the same manner as in Example 2-1.

### Example 2-3

In the tip end of the taper portions provided at the both end portions of the center pin, two cut-out portions of the rectangular shape shown in FIG. 12 were provided in a substantially uniform arrangement in which the intervals between the cut-out portions are substantially equal with each other, as shown in FIG. 13A. The width of each cut-out portion was set to the length of 35% as the ratio to the inner peripheral length of the tip end of the center pin. The depth of each cut-out portion was set to the length of 50% as the ratio to the length of the taper portion. The total width ratio of the cut-out portions was 70%. Except for the above, a cylindrical battery was fabricated in the same manner as in Example 2-1.

### Example 2-4

In the tip end of the taper portions provided at the both end portions of the center pin, three cut-out portions of the rectangular shape shown in FIG. 12 were provided in a substantially uniform arrangement in which the intervals among the cut-out portions are substantially equal from one another, as shown in FIG. 13B. The width of each cut-out portion was set to the length of 5% as the ratio to the inner peripheral length of the tip end of the center pin. The depth of each cut-out portion was set to the length of 50% as the ratio to the length of the taper portion. The total width ratio of the cut-out portions was 15%. Except for the above, a cylindrical battery was fabricated in the same manner as in Example 2-1.

### Example 2-5

In the tip end of the taper portions provided at the both end portions of the center pin, three cut-out portions of the rectangular shape shown in FIG. 12 were provided in a substantially uniform arrangement in which the intervals among the cut-out portions are substantially equal from one another, as shown in FIG. 13B. The width of each cut-out portion was set to the length of 20% as the ratio to the inner peripheral length of the tip end of the center pin. The depth of each cut-out portion was set to the length of 50% as the ratio to the length of the taper portion. The total width ratio of the cut-out portions was 60%. Except for the above, a cylindrical battery was fabricated in the same manner as in Example 2-1.

### Example 2-6

In the tip end of the taper portions provided at the both end portions of the center pin, three cut-out portions of the rectangular shape shown in FIG. 12 were provided in a substantially uniform arrangement in which the intervals among the cut-out portions are substantially equal from one another, as shown in FIG. 13B. The width of each cut-out portion was set to the length of 25% as the ratio to the inner peripheral length of the tip end of the center pin. The depth of each cut-out portion was set to the length of 50% as the ratio to the length of the taper portion. The total width ratio of the cut-out portions was 75%. Except for the above, a cylindrical battery was fabricated in the same manner as in Example 2-1.

### Example 2-7

In the tip end of the taper portions provided at the both end portions of the center pin, four cut-out portions of the rectangular shape shown in FIG. 12 were provided in a substantially uniform arrangement in which the intervals among the cut-out portions are substantially equal from one another, as shown in FIG. 13C. The width of each cut-out portion was set to the length of 5% as the ratio to the inner peripheral length of the tip end of the center pin. The depth of each cut-out portion was set to the length of 50% as the ratio to the length of the taper portion. The total width ratio of the cut-out portions was 20%. Except for the above, a cylindrical battery was fabricated in the same manner as in Example 2-1.

### Example 2-8

In the tip end of the taper portions provided at the both end portions of the center pin, four cut-out portions of the rectangular shape shown in FIG. 12 were provided in a substantially uniform arrangement in which the intervals among the cut-out portions are substantially equal from one another, as shown in FIG. 13C. The width of each cut-out portion was set to the length of 15% as the ratio to the inner peripheral length of the tip end of the center pin. The depth of each cut-out portion was set to the length of 50% as the ratio to the length of the taper portion. The total width ratio of the cut-out portions was 60%. Except for the above, a cylindrical battery was fabricated in the same manner as in Example 2-1.

### Example 2-9

In the tip end of the taper portions provided at the both end portions of the center pin, four cut-out portions of the rectangular shape shown in FIG. 12 were provided in a substantially uniform arrangement in which the intervals among the cut-out portions are substantially equal from one another, as shown in FIG. 13C. The width of each cut-out portion was set to the length of 20% as the ratio to the inner peripheral length of the tip end of the center pin. The depth of each cut-out portion was set to the length of 50% as the ratio to the length of the taper portion. The total width ratio of the cut-out portions was 80%. Except for the above, a cylindrical battery was fabricated in the same manner as in Example 2-1.

### Comparative Example 2-1

A cylindrical battery was fabricated in the same manner as in Comparative Example 1-1.

### Comparative Example 2-2

In the tip end of the taper portions provided at the both end portions of the center pin, one cut-out portion of the rectangular shape shown in FIG. 12 was provided by the arrangement shown in FIG. 13D. The width of the cut-out portion was set to the length of 5% as the ratio to the inner peripheral length of the tip end of the center pin. The depth of the cut-out portion was set to the length of 50% as the ratio to the length of the taper portion. The total width ratio of the cut-out portion was 5%. Except for the above, a cylindrical battery was fabricated in the same manner as in Example 2-1.

### Comparative Example 2-3

In the tip end of the taper portions provided at the both end portions of the center pin, one cut-out portion of the rectangular shape shown in FIG. 12 was provided by the arrangement shown in FIG. 13D. The width of the cut-out portion was set to the length of 35% as the ratio to the inner peripheral length of the tip end of the center pin. The depth of the cut-out portion was set to the length of 50% as the ratio to the length of the taper portion. The total width ratio of the cut-out portion was 35%. Except for the above, a cylindrical battery was fabricated in the same manner as in Example 2-1.

[Evaluations]

On Examples 2-1 to 2-9 and Comparative examples 2-1 to 2-3, the “fire test (of one battery each)” as in the above and the following “check of productivity at the time of component supply” and “check of productivity at the time of component insertion” were performed. It should be noted that the “fire test” was performed on one battery for each of Examples and Comparative Examples.

(Check of Productivity at the Time of Component Supply)

A parts feeder (manufacturer: Sinfonia Technology Co., Ltd. (former Shinko Electric Industries Co., Ltd.), model: DM-38B) which supplies the center pins was provided with one thousand center pins. Then, after starting it up, deformation of the tip end portion of the center pin in the parts feeder was checked by visual observation.

(Check of Productivity at the Time of Component Insertion)

When inserting the center pin into the center of the spirally wound electrode body, it was checked whether or not there was an occurrence of insertion failure in which the center pin is caught in the separator at the center of the spirally wound electrode body.

The test results of Examples 2-1 to 2-9 and Comparative Examples 2-1 to 2-3 are shown in Table 2. The determination was made according to the following criteria.

⊚ (meaning “very good”): In the above evaluations, the moving distance in the fire test was 0.7 meters or less, the check of productivity at the time of component supply showed no deformation, and the check of productivity at the time of component insertion showed no insertion failure.

◯ (meaning “good”): The moving distance in the fire test was 0.7 meters or less, and the check of productivity at the time of component supply showed deformation or the check of productivity at the time of component insertion showed insertion failure.

× (meaning “bad”): The moving distance in the fire test was greater than 0.7 meters (regardless of the outcome of the check of productivity at the time of component supply and the check of productivity at the time of component insertion).

TABLE 2

| | Center pin tip end portion | | The number of | (Total) Width of | Width ratio of one | | | |
|---|---|---|---|---|---|---|---|---|
| | Shape of cut-out | | cut-out | cut-out portion(s) | cut-out portion | | | |
| | portion(s) | Arrangement | portion(s) | (mm) | 1 | 2 | 3 | 4 |
| Ex. 2-1 | Rectangular (FIG. 12) | FIG. 13A | 2 | 0.72 | 5 | 5 | — | — |
| Ex. 2-2 | Rectangular (FIG. 12) | FIG. 13A | 2 | 4.34 | 30 | 30 | — | — |
| Ex. 2-3 | Rectangular (FIG. 12) | FIG. 13A | 2 | 5.06 | 35 | 35 | — | — |
| Ex. 2-4 | Rectangular (FIG. 12) | FIG. 13B | 3 | 1.08 | 5 | 5 | 5 | — |
| Ex. 2-5 | Rectangular (FIG. 12) | FIG. 13B | 3 | 4.34 | 20 | 20 | 20 | — |
| Ex. 2-6 | Rectangular (FIG. 12) | FIG. 13B | 3 | 5.42 | 25 | 25 | 25 | — |
| Ex. 2-7 | Rectangular (FIG. 12) | FIG. 13C | 4 | 1.44 | 5 | 5 | 5 | 5 |
| Ex. 2-8 | Rectangular (FIG. 12) | FIG. 13C | 4 | 4.34 | 15 | 15 | 15 | 15 |
| Ex. 2-9 | Rectangular (FIG. 12) | FIG. 13C | 4 | 5.76 | 20 | 20 | 20 | 20 |
| Comp. Ex. 2-1 | — | — | 0 | 0 | — | — | — | — |
| Comp. Ex. 2-2 | Rectangular (FIG. 12) | FIG. 13D | 1 | 0.36 | 5 | — | — | — |
| Comp. Ex. 2-3 | Rectangular (FIG. 12) | FIG. 13D | 1 | 2.53 | 35 | — | — | — |

| Total | | | | | |
|---|---|---|---|---|---|
| width | Depth of | Fire test | | | |
| ratio | cut-out portion | (distance of | Check of producivity | Check of productivity | |
| (%) | (%) | cell movement) | (component supply) | (component insertion) | Determination |
| 10 | 50 | 0.5 m | No deformation | No insertion failure | ⊚ |
| 60 | 50 | 0.1 m | No deformation | No insertion failure | ⊚ |
| 70 | 50 | 0 m (Not moved) | Deformation occurred | Insertion failure occurred | ◯ |
| 15 | 50 | 0.3 m | No deformation | No insertion failure | ⊚ |
| 60 | 50 | 0 m (Not moved) | No deformation | No insertion failure | ⊚ |
| 75 | 50 | 0 m (Not moved) | Deformation occurred | Insertion failure occurred | ◯ |
| 20 | 50 | 0 m (Not moved) | No deformation | No insertion failure | ⊚ |
| 60 | 50 | 0 m (Not moved) | No deformation | No insertion failure | ⊚ |
| 80 | 50 | 0 m (Not moved) | Deformation occurred | Insertion failure occurred | ◯ |
| 0 | 0 | 3 m | No deformation | No insertion failure | X |
| 5 | 50 | 2 m | No deformation | No insertion failure | X |
| 35 | 50 | 1 m | No deformation | Insertion failure occurred | X |

In Examples 2-1 and 2-2, 2-4 and 2-5, and 2-7 and 2-8, good determination result was obtained. On the other hand, in Example 2-3, the width ratio of one cut-out portion was greater than 30%, and as a result, the productivity was poor. In Example 2-6, the total width ratio of the cut-out portions was greater than 60%, and as a result, the productivity was poor. In Example 2-9, the total width ratio of the cut-out portions was greater than 60%, and as a result, the productivity was poor.

### Example 3-1

In the tip end of the taper portions provided at the both end portions of the center pin, two cut-out portions of the rectangular shape shown in FIG. 12 were provided in a substantially uniform arrangement in which the intervals between the cut-out portions are substantially equal with each other, as shown in FIG. 13A. The width of each cut-out portion was set to the length of 30% as the ratio to the inner peripheral length of the tip end of the center pin. The depth of each cut-out portion was set to the length of 50% as the ratio to the length of the taper portion. The total width ratio of the cut-out portions was 60%. Except for the above, a cylindrical battery was fabricated in the same manner as in Example 1-1.

### Example 3-2

Except that the depth of each cut-out portion was set to the length of 80% as the ratio to the length of the taper portion, a cylindrical battery was fabricated in the same manner as in Example 3-1.

### Example 3-3

Except that the depth of each cut-out portion was set to the length of 110% as the ratio to the length of the taper portion, a cylindrical battery was fabricated in the same manner as in Example 3-1.

### Example 3-4

In the tip end of the taper portions provided at the both end portions of the center pin, three cut-out portions of the rectangular shape shown in FIG. 12 were provided in a substantially uniform arrangement in which the intervals among the cut-out portions are substantially equal from one another, as shown in FIG. 13B. The width of each cut-out portion was set to the length of 20% as the ratio to the inner peripheral length of the tip end of the center pin. The depth of each cut-out portion was set to the length of 50% as the ratio to the length of the taper portion. The total width ratio of the cut-out portions was 60%. Except for the above, a cylindrical battery was fabricated in the same manner as in Example 3-1.

### Example 3-5

Except that the depth of each cut-out portion was set to the length of 80% as the ratio to the length of the taper portion, a cylindrical battery was fabricated in the same manner as in Example 3-4.

### Example 3-6

Except that the depth of each cut-out portion was set to the length of 110% as the ratio to the length of the taper portion, a cylindrical battery was fabricated in the same manner as in Example 3-4.

### Example 3-7

In the tip end of the taper portions provided at the both end portions of the center pin, four cut-out portions of the rectangular shape shown in FIG. 12 were provided in a substantially uniform arrangement in which the intervals among the cut-out portions are substantially equal from one another, as shown in FIG. 13C. The width of each cut-out portion was set to the length of 15% as the ratio to the inner peripheral length of the tip end of the center pin. The depth of each cut-out portion was set to the length of 50% as the ratio to the length of the taper portion. The total width ratio of the cut-out portions was 60%. Except for the above, a cylindrical battery was fabricated in the same manner as in Example 3-1.

### Example 3-8

Except that the depth of each cut-out portion was set to the length of 80% as the ratio to the length of the taper portion, a cylindrical battery was fabricated in the same manner as in Example 3-7.

### Example 3-9

Except that the depth of each cut-out portion was set to the length of 110% as the ratio to the length of the taper portion, a cylindrical battery was fabricated in the same manner as in Example 3-7.

[Evaluations]

On Examples 3-1 to 3-9, the “fire test”, the “check of productivity at the time of component supply” and the “check of productivity at the time of component insertion” as in the above were performed. It should be noted that the “fire test” was performed on one battery for each of Examples.

The test results of Examples 3-1 to 3-9 are shown in Table 3.

TABLE 3

| | Center pin tip end portion | | The number of | (Total) Width of | Width ratio of | | | |
|---|---|---|---|---|---|---|---|---|
| | Shape of cut-out | | cut-out | cut-out portion(s) | one cut-out portion | | | |
| | portion(s) | Arrangement | portion(s) | (mm) | 1 | 2 | 3 | 4 |
| Ex. 3-1 | Rectangular (FIG. 12) | FIG. 13A | 2 | 4.34 | 30 | 30 | — | — |
| Ex. 3-2 | Rectangular (FIG. 12) | FIG. 13A | 2 | 4.34 | 30 | 30 | — | — |
| Ex. 3-3 | Rectangular (FIG. 12) | FIG. 13A | 2 | 4.34 | 30 | 30 | — | — |
| Ex. 3-4 | Rectangular (FIG. 12) | FIG. 13B | 3 | 4.34 | 20 | 20 | 20 | — |
| Ex. 3-5 | Rectangular (FIG. 12) | FIG. 13B | 3 | 4.34 | 20 | 20 | 20 | — |
| Ex. 3-6 | Rectangular (FIG. 12) | FIG. 13B | 3 | 4.34 | 20 | 20 | 20 | — |
| Ex. 3-7 | Rectangular (FIG. 12) | FIG. 13C | 4 | 4.34 | 15 | 15 | 15 | 15 |
| Ex. 3-8 | Rectangular (FIG. 12) | FIG. 13C | 4 | 4.34 | 15 | 15 | 15 | 15 |
| Ex. 3-9 | Rectangular (FIG. 12) | FIG. 13C | 4 | 4.34 | 15 | 15 | 15 | 15 |

| Total | Depth of | | | | |
|---|---|---|---|---|---|
| width | cut-out | Fire test (distance of | Check of producivity | Check of productivity | |
| ratio (%) | portion (%) | cell movement) | (component supply) | (component insertion) | Determination |
| 60 | 50 | 0.1 m | No deformation | No insertion failure | ⊚ |
| 60 | 80 | 0 m (Not moved) | Deformation occurred | No insertion failure | ◯ |
| 60 | 110 | 0 m (Not moved) | Deformation occurred | Insertion failure occurred | ◯ |
| 60 | 50 | 0 m (Not moved) | No deformation | No insertion failure | ⊚ |
| 60 | 80 | 0 m (Not moved) | Deformation occurred | No insertion failure | ◯ |
| 60 | 110 | 0 m (Not moved) | Deformation occurred | Insertion failure occurred | ◯ |
| 60 | 50 | 0 m (Not moved) | No deformation | No insertion failure | ⊚ |
| 60 | 80 | 0 m (Not moved) | Deformation occurred | No insertion failure | ◯ |
| 60 | 110 | 0 m (Not moved) | Deformation occurred | Insertion failure occurred | ◯ |

As shown in Table 3, according to Examples 3-1 to 3-9, when the depth of the cut-out portion was greater than 50% with respect to the length of the taper portion, the productivity decreased. In other words, it was found that it may be desirable that the depth of the cut-out portion is 50% or less with respect to the length of the taper portion.

### Example 4-1

A cylindrical battery was fabricated in the same manner as in Example 3-1.

### Example 4-2

In the tip end of the taper portions provided at the both end portions of the center pin, two cut-out portions of the rectangular shape shown in FIG. 12 were provided in an arrangement in which the intervals between the cut-out portions are unequal with each other, as shown in FIG. 13E. Except for the above, a cylindrical battery was fabricated in the same manner as in Example 4-1.

### Example 4-3

A cylindrical battery was fabricated in the same manner as in Example 3-4.

### Example 4-4

In the tip end of the taper portions provided at the both end portions of the center pin, three cut-out portions of the rectangular shape shown in FIG. 12 were provided in an arrangement in which the intervals among the cut-out portions are unequal, as shown in FIG. 13F. Except for the above, a cylindrical battery was fabricated in the same manner as in Example 4-3.

### Example 4-5

A cylindrical battery was fabricated in the same manner as in Example 3-7.

### Example 4-6

In the tip end of the taper portions provided at the both end portions of the center pin, four cut-out portions of the rectangular shape shown in FIG. 12 were provided in an arrangement in which the intervals among the cut-out portions are unequal, as shown in FIG. 13G. Except for the above, a cylindrical battery was fabricated in the same manner as in Example 4-5.

[Evaluations]

On Examples 4-1 to 4-6, the “fire test (of one battery each)”, the “check of productivity at the time of component supply” and the “check of productivity at the time of component insertion” as in the above were performed.

The test results of Examples 4-1 to 4-6 are shown in Table 4.

TABLE 4

| | Center pin tip end portion | | The number of | (Total) Width of | Width ratio of | | | |
|---|---|---|---|---|---|---|---|---|
| | Shape of cut-out | | cut-out | cut-out portion(s) | one cut-out portion | | | |
| | portion(s) | Arrangement | portion(s) | (mm) | 1 | 2 | 3 | 4 |
| Ex. 4-1 | Rectangular (FIG. 12) | FIG. 13A | 2 | 4.34 | 30 | 30 | — | — |
| Ex. 4-2 | Rectangular (FIG. 12) | FIG. 13E | 2 | 4.34 | 30 | 30 | — | — |
| Ex. 4-3 | Rectangular (FIG. 12) | FIG. 13B | 3 | 4.34 | 20 | 20 | 20 | — |
| Ex. 4-4 | Rectangular (FIG. 12) | FIG. 13F | 3 | 4.34 | 20 | 20 | 20 | — |
| Ex. 4-5 | Rectangular (FIG. 12) | FIG. 13C | 4 | 4.34 | 15 | 15 | 15 | 15 |
| Ex. 4-6 | Rectangular (FIG. 12) | FIG. 3G | 4 | 4.34 | 15 | 15 | 15 | 15 |

| Total | Depth | | | Check of | | |
|---|---|---|---|---|---|---|
| width | of cut-out | | | productivity | | |
| ratio | portion | Arrangement of | Fire test (distance of | (component | Check of productivity | |
| (%) | (%) | cut-out portion | cell movement) | supply) | (component insertion) | Determination |
| 60 | 50 | Uniform | 0.1 m | No deformation | No insertion failure | ⊚ |
| 60 | 50 | Non-uniform | 0.5 m | No deformation | No insertion failure | ◯ |
| 60 | 50 | Uniform | 0 m (Not moved) | No deformation | No insertion failure | ◯ |
| 60 | 50 | Non-uniform | 0.3 m | No deformation | No insertion failure | ⊚ |
| 60 | 50 | Uniform | 0 m (Not moved) | No deformation | No insertion failure | ◯ |
| 60 | 50 | Non-uniform | 0.1 m | No deformation | No insertion failure | ◯ |

As shown in Table 4, according to Examples 4-1 to 4-6, when the cut-out portions were provided in the substantially uniform arrangement, the distance of battery cell movement in the fire test was smaller than that in the case where the cut-out portions were provided in the non-uniform arrangement. In other words, it was found that it may be more desirable to provide the cut-out portions in the substantially uniform arrangement than to provide the cut-out portions in the non-uniform arrangement.

### 4. Other Embodiments

The present disclosure is not limited to the above-described embodiments, but various modifications and alternatives of the embodiments may be made within the scope not departing from the gist of the present disclosure. For example, in the above-described embodiments and Examples, numerical values, structures, shapes, materials, raw materials, manufacturing methods and the like are illustrative only, and numerical values, structures, shapes, materials, raw materials, manufacturing methods and the like, which are different from that described above, may be used as appropriate.

Moreover, the configurations, the methods, the processes, the shapes, the materials, the numerical values and the like in the foregoing embodiments and Examples may be combined with each other without departing from the spirit of the present disclosure.

For example, although in the foregoing embodiments and Examples, the description has been given of the batteries using lithium as the reactive electrode material, an embodiment of the present disclosure may also be applied to batteries using any of other alkali metals such as potassium (K) and sodium (Na), alkaline earth metals such as magnesium and calcium (Ca), and other light metals such as aluminum.

In the foregoing embodiments, the electrode body was one including the positive electrode and the negative electrode with the separator therebetween, which is configured to prevent short-circuit between the positive electrode and the negative electrode. However, in place of the separator, there may be used an ion conductor such as a gel electrolyte and a solid electrolyte. In addition, the electrode body may also include an ion conductor such as a gel electrolyte where a polymer compound is swollen with the electrolyte solution, and a solid electrolyte, together with the separator. Furthermore, the present disclosure can be applied to not only a secondary battery but also a primary battery.

The present disclosure may have the following configurations.

[1] A battery, including:
a spirally wound electrode body including a positive electrode and a negative electrode spirally wound and having a hollow portion;
a center pin, provided in the hollow portion of the spirally wound electrode body, including at least one end having a plurality of cut-out portions; and
an exterior body configured to house the spirally wound electrode body and the center pin.
   [2] The battery according to [1], in which
the center pin includes at least one end having a taper portion that is tapered, and
the cut-out portions are provided within the taper portion.
   [3] The battery according to [1] or [2], in which
each of the cut-out portions is arranged at substantially equal intervals from one another.
   [4] The battery according to any one of [1] to [3], in which
the width ratio of a cut-out portion included in the cut-out portions is 5% or more and 30% or less, in percentage of the width of one cut-out portion with respect to the length of the inner periphery of a tip end of the center pin.
   [5] The battery according to any one of [1] to [4], in which
the total of the width ratio of the cut-out portions is 60% or less, in percentage of the total width of the cut-out portions with respect to the length of the inner periphery of a tip end of the center pin.
   [6] The battery according to [2], in which
the depth of a cut-out portion included in the cut-out portions is 50% or less with respect to the length of the taper portion.
   [7] The battery according to any one of [1] to [6], in which
the cut-out portions are provided in the both ends of the center pin.
   [8] The battery according to any one of [1] to [7], in which
the thickness of the center pin is 0.05 mm or more and 1.0 mm or less.
   [9] The battery according to any one of [1] to [8], in which
the exterior body is a substantially cylindrical battery can.
   [10] The battery according to [9], in which
the cut-out portions are provided in at least the end of the center pin located at the open end side of the battery can.
   [11] The battery according to any one of [1] to [10], in which
the center pin is a cylindrical body having a hollow structure.
   [12] The battery according to any one of [1] to [11], in which
the spirally wound electrode body further includes a separator provided between the positive electrode and the negative electrode.
   [13] A center pin including:
at least one end having a plurality of cut-out portions.
   [14] A battery pack including:
the battery according to [1];
a control unit configured to control the battery; and
an exterior configured to contain the battery.
   [15] An electronic apparatus including:

the battery according to [1],
the electronic apparatus being configured to receive electricity supply from the battery.
   [16] An electric tool including:

the battery according to [1],
the electric tool being configured to receive electricity supply from the battery.
   [17] An electric vehicle including:
the battery according to [1];
a converter configured to

receive electricity supply from the battery and

convert the electricity into driving force for vehicle; and
a controller configured to process information on vehicle control on the basis of information on the battery.
   [18] An electrical storage apparatus including:

the battery according to [1],
the electrical storage apparatus being configured to provide electricity to an electronic apparatus connected to the battery.
   [19] The electrical storage apparatus according to [18], further including:

an electricity information controlling device configured to transmit and receive signals via a network to and from other apparatus,
the electrical storage apparatus being configured to control charge and discharge of the battery on the basis of information that the electricity information controlling device receives.
   [20] An electricity system, configured to
receive electricity supply from the battery according to [1]; or
provide electricity from at least one of a power generating device and a power network to the battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A battery, comprising:
a spirally wound electrode body including a positive electrode and a negative electrode spirally wound and having a hollow portion;
a center pin, disposed in the hollow portion of the spirally wound electrode body, including at least one end having a plurality of cut-out portions; and
an exterior body configured to house the spirally wound electrode body and the center pin.

2. The battery according to claim 1, wherein
the center pin includes at least one end having a taper portion that is tapered, and
the cut-out portions are provided within the taper portion.

3. The battery according to claim 1, wherein
each of the cut-out portions is arranged at substantially equal intervals from one another.

4. The battery according to claim 1, wherein
the width ratio of a cut-out portion included in the cut-out portions is 5% or more and 30% or less, in percentage of the width of one cut-out portion with respect to the length of the inner periphery of a tip end of the center pin.

5. The battery according to claim 1, wherein
the total of the width ratio of the cut-out portions is 60% or less, in percentage of the total width of the cut-out portions with respect to the length of the inner periphery of a tip end of the center pin.

6. The battery according to claim 2, wherein
the depth of a cut-out portion included in the cut-out portions is 50% or less with respect to the length of the taper portion.

7. The battery according to claim 1, wherein
the cut-out portions are provided in the both ends of the center pin.

8. The battery according to claim 1, wherein
the thickness of the center pin is 0.05 mm or more and 1.0 mm or less.

9. The battery according to claim 1, wherein
the exterior body is a substantially cylindrical battery can.

10. The battery according to claim 9, wherein
the cut-out portions are provided in at least the end of the center pin located at the open end side of the battery can.

11. The battery according to claim 1, wherein
the center pin is a cylindrical body having a hollow structure.

12. The battery according to claim 1, wherein
the spirally wound electrode body further includes a separator provided between the positive electrode and the negative electrode.

13. A center pin, comprising:
at least one end having a plurality of cut-out portions.

14. A battery pack, comprising:
the battery according to claim 1;
a control unit configured to control the battery; and
an exterior configured to contain the battery.

15. An electronic apparatus, comprising:
the battery according to claim 14,
the electronic apparatus being configured to receive electricity supply from the battery.

16. An electric tool, comprising:
the battery according to claim 14,
the electronic apparatus being configured to receive electricity supply from the battery.

17. An electric vehicle, comprising:
the battery according to claim 1;
a converter configured to
receive electricity supply from the battery and
convert the electricity into driving force for vehicle; and
a controller configured to process information on vehicle control on the basis of information on the battery.

18. An electrical storage apparatus, comprising:
the battery according to claim 1,
the electrical storage apparatus being configured to provide electricity to an electronic apparatus connected to the battery.

19. The electrical storage apparatus according to claim 18, further comprising:
an electricity information controlling device configured to transmit and receive signals via a network to and from other apparatus,
the electrical storage apparatus being configured to control charge and discharge of the battery on the basis of information that the electricity information controlling device receives.

20. An electricity system, configured to
receive electricity supply from the battery according to claim 1; or
provide electricity from at least one of a power generating device and a power network to the battery.
